(19) United States
(12) Patent Application Publication
(10) Pub. No.: US 2016/0012535 A1
(43) Pub. Date: Jan. 14, 2016

(54) Data Processing System and Method for Deriving and Publishing Knowledge of Registered Investment Advisors and Related Entities and People

(71) Applicant: Convergence, Inc., Wilton, CT (US)

(72) Inventors: John F. Phinney, JR., Wilton, CT (US); George F. Evans, Whitehouse Station, NJ (US); Russell Klein, Framingham, MA (US); Rodney Lopez, Lowell, MA (US); Curtis J. Kjellman, Hudson, NH (US); Matthew C. Smith, Londonderry, NH (US); Gaurav Patil, Burlington, MA (US)

(73) Assignee: CONVERGENCE, INC., Wilton, CT (US)

(21) Appl. No.: 14/754,117

(22) Filed: Jun. 29, 2015

Related U.S. Application Data
(60) Provisional application No. 62/023,541, filed on Jul. 11, 2014.
(60) Provisional application No. 62/184,656, filed on Jun. 25, 2015.

(51) Int. Cl. G06Q 40/06

(52) U.S. Cl. CPC G06Q 40/06

(57) ABSTRACT

A system for deriving and managing RIA knowledge employs a data collection server and data processing system. The data collection server is configured to communicate with at least one data source to collect publically-available information pertaining to RIAs and stores such information in a first database. The data processing system processes the publically-available information stored in the first database to derive artifacts representing the publically-available information as well as additional artifacts that represent useful information beyond the publically-available information, and stores the artifacts and additional artifacts in a second database for output and/or analysis by users. The artifacts and additional artifacts that pertain to a particular RIA can be derived from both structured and unstructured data reported by the particular RIA to a regulatory authority.

### CROSS-REFERENCE TO RELATED APPLICATIONS

The present application claims priority from U.S. Provisional Patent Appl. No. 62/023,541, filed on Jul. 11, 2014, and from U.S. Provisional Patent Appl. No. 62/184,656, filed on Jun. 25, 2015, herein incorporated by reference in their entireties.

### BACKGROUND

1. Field

The present application relates to data processing systems and methods for deriving and publishing financial information.

2. Related Art

Registered Investment Advisors, hereafter referred to as “RIAs”, who provide advisory services to private hedge funds, liquidity funds, private equity funds, real estate funds, securitized asset funds, and venture capital funds form what is called the “alternative asset management industry.” The private funds of the alternative asset management industry are exempt from registration under Regulation D. Investment advisors employ financial structures (private funds) that pool and invests such monies in an effort to generate positive returns that are typically intended to be less correlated to returns available by investing through registered public funds. These investment advisors, and the private funds they advise, typically have more investment flexibility than comparable investments available through publicly traded funds, such as mutual funds and exchange-traded funds, because their private funds are exempt from registration under Regulation D. Many alternative investments seek to profit in positive, negative and neutral of markets by using leverage (in other words, borrowing to increase investment exposure as well as risk), short-selling and other investment practices that registered public funds are restricted from using. In the United States, private funds are not subject to the same type of standardized public reporting requirements, nor the breadth and depth of regulations, designed to inform and protect investors in publicly traded registered funds. As a result, investors eligible to invest in private funds have far less public information available to them when considering an investment in a private fund. The term investor can include (i) individuals (typically high net worth individuals who are “qualified” investors), (ii) public and private pension plans (and indirectly the millions of current and retired plan members) and (iii) endowments and foundations. Current estimates suggest that investors have allocated almost 3 trillion dollars to private funds.

An “Investment Adviser” as defined by the securities law of the United States is a person or company that makes investment recommendations or conducts securities analysis in return for a fee, whether through direct management of client assets or via written publications. Certain Investment Advisors, including certain Investment Advisors that advise on alternative investments, are required by the laws of the United States to submit a report (“Form ADV”) with the SEC through the Investment Adviser Registration Depository (“IARD”), which is a registration system managed by the Financial Industry Regulatory Authority (“FINRA”). Form ADV can have four parts: part 1A, part 1B, part 2A and part 2B. Such Investment Advisors are referred to as Registered Investment Advisors or RIAs herein. For RIAs that advise on alternative investments, the clients of such RIAs can be the limited partners of a private fund, the general manager of a private fund, a private fund itself or other parties.

Part 1A of the Form ADV identifies the following information about the RIA submitting the Form ADV:

(a) basic contact information such as the RIA's legal and “doing business as” names, contact person's name, office address and telephone number, and office hours of the RIA;

(b) the basis for the registration;

(c) the organizational form of the RIA;

(d) description of the business of the RIA;

(e) the types of clients advised by the RIA;

(f) the fee and compensation arrangements of the RIA;

(g) the types of investment advisory activities of the RIA;

(h) other business activities of the RIA;

(i) the location of books and records of the RIA;

(j) information regarding financial industry affiliations and activities of the RIA;

(k) information regarding involvement of the RIA and related parties in transactions such as a proprietary or sales interest or use of discretion or other potential conflicts of interest;

(l) whether the RIA maintains custody of client's assets;

(m) information regarding people that directly or indirectly control the RIA;

(n) whether the RIA or affiliate has been convicted of a felony or investment-related misdemeanor, or subject to an adverse regulatory finding, censure or fine, or a court judgment related to violation of investment-related statute or regulation; and

(o) percentage of regulatory assets under management per type of client disclosed in item (e) above.

Part 1A of the Form ADV also includes several schedules as follows. Schedule A names key executive officers of the RIA, which must name a Chief Compliance Officer. Other key executive officers can be named, including but not limited to Chief Executive Officer, Chief Operations Officer, Chief Financial Officer and other C-Level associates. Schedule A also names direct owners of the RIA with a 5% or more ownership interest. Schedule B names all of the indirect owners with a 25% or more ownership interest of a direct owner. Schedule C lists amendments to information on either Schedule A or Schedule B. Schedule D lists other miscellaneous information such as (i) other office locations, (ii) World Wide Web addresses, (iii) location of books and records, (iv) registration with Foreign Financial Regulatory Authorities, (v) other business names, and vi) information on private funds advised by the RIA and affiliates of the RIA.

Part 1B of the Form ADV requests the following information from a state registered RIA, including i) those states where the RIA is applying for registration, ii) the supervisory and compliance principal, iii) information about the surety bond if required by the RIA's home state, (iv) affiliates of the RIA (such as broker dealers and other RIAs) as well as information regarding control of and/or control by such affiliates, and (v) information regarding private funds that are advised by the RIA applicant, including information regarding master-feeder arrangements and fund-of-funds arrangements and information regarding service providers (such as auditors, prime brokers, custodians, administrators, custodians, and marketers). A Disciplinary Reporting Page (DRP) provides details about felony or investment-related misdemeanor, regulatory discipline, or court judgments related to violation of investment-related statutes and regulations by the RIA applicant or its affiliated persons. The DRP can also provide information about unsatisfied judgment and liens, investment-related arbitrations and civil judicial action, and other miscellaneous information.

Part 2A (the “Brochure”) of the Form ADV includes information about a variety of topics, including (i) material changes to the business of the RIA, (ii) a table of contents, (iii) a description of the business of the RIA, (iv) fees and compensation including a description of expenses that clients may incur for the funds advised by the RIA, (v) a description of the types of performance fees the clients may pay to and a description of side-by-side investment practices, (vi) types of clients advised by the RIA, (vii) a description of the methods of analysis, investment strategies and risk of the RIA, (viii) any disciplinary actions experienced by the RIA and its affiliates, (ix) a description of industry activities and affiliations, (x) a description of the RIA's code of ethics, participation or interest in transactions and personal trading policies and procedures, (xi) a description of the RIA's brokerage practices, (xii) a description of how the RIA monitors and reviews client accounts, (xiii) a description of how the RIA manages referrals and other compensation that it receives other than what is described in (iv) and (v) above, (xiv) a description of custody practices, (xv) a description of the investment discretion the RIA has over assets, (xvi) a description of how the RIA votes on matters related to the investments it advises on behalf of clients, and (xvii) financial information in cases where the RIA is paid fees in advance.

Part 2B (the “Brochure Supplement”) of the Form ADV includes information about certain RIA personnel. For each “supervised person” who provides advisory services to a client of the RIA, the Brochure Supplement includes disclosing, among other things: (i) his or her formal education and business background; (ii) certain legal or disciplinary events; (iii) other capacities in which he or she participates in any investment-related business; (iv) any compensation he or she receives based on the sales of securities or other investment products; and (v) economic benefits he or she receives from someone other than a client of the RIA for providing advisory services.

Parts 1A, 1B, 2A and 2B of the Form ADV must be filed annually. Brochure Supplements, when filed, are not required to be filed electronically, and are not made publicly available on the IARD website. An update of Parts 1A, 1B, 2A and 2B of the Form ADV is filed on an annual basis and/or whenever information previously filed by the RIA becomes materially inaccurate. In addition, updates to the Brochure and Brochure Supplement are filed due to the occurrence of a disciplinary event or changes to material information relating to a disciplinary event. Parts 1A, 1B, 2A and 2B of the Form ADV (and its updates) are made publically available on the IARD website with daily updates available Tuesday through Friday and Sunday. In summary, these documents contain almost two thousand pieces of information on the RIA and its business practices.

Clients (including limited partners) who seek to allocate capital to RIAs of alternative investments and service providers that offer services to RIAs of alternative investments conduct “due diligence”, which is a process designed to examine the RIA. Due diligence is designed to gather information about the RIA and the private funds they advise, including but not limited (i) the RIA's investment strategy, (ii) its investment process, (iii) its business operations, (iv) investment, legal, reputational, operating and financial risks and (v) the control environment in place to manage these factors. Due diligence results in a decision by clients to invest, or not invest, with the RIA. Clients use information collected during due diligence to negotiate the management and incentive fees they will pay the RIA and the expenses they will bear in a private fund. Service providers use information collected during due diligence to create service level agreements, agree on liability sharing and set fee levels.

Clients (including limited partners), service providers and other RIAs of alternative investments have had broad access to data (referred to below as the RIA's “performance track record” or “performance data”) to help them evaluate and benchmark the investment returns generated by one or more RIAs. For example, a limited partner who is seeking a list of all RIAs who have generated a 6% annual investment return for 5 years through an investment grade corporate bond strategy can access the performance data for one or more RIAs from a number of companies who specialize in collecting data directly from the RIAs (typically by surveys or interviews) and deriving performance data for the RIAs. The term “performance data” in this context means the risks taken and the investment returns that the RIA has generated on investments that it has made on behalf of its clients. The performance data can also be used by other participants in the marketplace of alternative investments.

Clients (including limited partners), service providers (such as auditors, prime brokers, custodians, administrators, and marketers), counter-parties, business associates and others can access the IARD website to retrieve non-performance information that can aid them in conducting due diligence on RIAs of alternative investments. However, the form and structure of the data provided in the IARD filings is difficult to obtain and, when data can be obtained, it is a combination of numeric and textual values. Furthermore, the data may be unstructured, meaning it can easily be taken out of context, it can be inaccurate, incomplete and highly technical and complex. For example, RIAs disclose what are called Feeder Funds in Schedule D, Item 7B1 of the Form ADV. Feeder Funds can be combined to form what is known as a Master Fund, or they may stand alone, meaning they do not belong to a Master Fund. A Feeder Fund is a legal entity whose purpose is to collect funds from limited partners and then invest the funds in the shares of a Master Fund, whose purpose is make investments. The RIA provides the gross asset values for both the Feeder and Master Funds in Schedule D Item 7B1 of the Form ADV. Users of this Form ADV data who want to identify the gross asset value for particular funds and RIAs may incorrectly add the values of the Feeder and Master Funds together, when, in fact, the total value of the RIA Fund is the only value of the Master Fund when there is a clear and direct relationship between the Feeder and Master Fund. When there is no relationship between a Feeder and a Master Fund, it would be correct to sum the value of all Feeders and Master Funds that meet with these conditions. Moreover, they may not be able to aggregate all of the fund data for a group of affiliated RIAs because there is no standard identification code used by affiliated advisors that would identify them with a common control entity. These conditions cannot be clearly seen in the ADV data. In other cases, there is a lack of transparency into the complex nature of the RIAs who advise these funds and thus no easy way for limited partners to compare and contrast (benchmark) the business complexity or regulatory assets under management for two or more seemingly similar RIAs. It is almost impossible for limited partners and others to associate, consolidate and analyze the data filed by 15,000 RIAs on the 44,000 private funds they advise, all of which is contained within the IARD database. As a result, it is equally almost impossible to identify, flag and trend changes in the complexity, practices, operating risks and expenses of RIAs as disclosed by these RIAs in all parts of their form ADV.

Investor's conducting due diligence on RIAs want to determine the RIAs ability to generate returns and the RIAs ability to run and sustain a viable business. The cost of running and managing one or more RIAs is a direct function of the complexity of their investment process, the fund structures they set-up to raise and invest capital, the variety of private funds they advise, the variety of domestic versus international locations, the number and type of investors they serve and the number of regulatory bodies that oversee their activities. The maxim of “complexity drives risk and risk drives cost” is a key consideration during due diligence. Investors will choose to invest with RIAs who generate target returns with less complexity than RIAs with similar returns with more complexity for the reason that fund expenses, driven by investment and non-investment activities, reduce fund returns. Limited partners who choose to invest with less complex RIAs increase the likelihood that they will achieve their expected returns by generating the highest gross returns at the lowest possible cost. Gross returns are defined as the profit or loss generated on investments before fees and expenses are deducted from the profit or added to the losses. Limited partners have access to structured data that helps them benchmark a RIAs gross and net returns yet they have far less transparency and information about business complexity and risk across multiple RIAs to help them benchmark the activities and practices, and related expenses that represent the difference between gross and net. The little information that is available can be difficult and expensive to find as it is distributed in pieces across a number of sources, including government and private records. In many cases, like Form ADV, the data is un-aggregated and in many cases unusable in its raw form.

### SUMMARY

The present application describes a system for deriving and managing RIA knowledge that employs a data collection server and data processing system. The data collection server is configured to communicate with at least one data source to collect publically-available information pertaining to RIAs and stores such information in a first database. The data processing system processes the publically-available information stored in the first database to derive artifacts representing the publically-available information as well as additional artifacts that represent useful information beyond the publically-available information, and stores the artifacts and additional artifacts in a second database for output and/or analysis by users. The artifacts and additional artifacts that pertain to a particular RIA can be derived from both structured and unstructured data reported by the particular RIA to a regulatory authority.

The data processing system can be configured to process the structured data reported by the particular RIA in order to generate at least one artifact for the particular RIA. In one embodiment, the at least one artifact for the particular RIA can relate specifically to one of: the particular RIA, their investments (including private funds), service providers of the particular RIA, disciplinary violations of the particular RIA, and an executive of the particular RIA.

The data processing system can be configured to parse free form text reported by the particular RIA into discrete sections, parse at least one given section of the free form text using a predefined key expression schema to create a score matrix for the given section of free form text, and apply at least one predefined rule to the score matrix for the given section of free form text in order to generate at least one additional artifact for the particular RIA. In one embodiment, the at least one additional artifact generated by application of the at least one predefined rule to the score matrix for the given section of free form text can represent an investment strategy that is assigned from one a number of predefined types of investment strategies.

In yet another embodiment, the at least one additional artifact for the particular RIA can represent information selected from the group consisting of:
number of employees that do not perform investment advisory functions,
total value of private funds managed by the particular RIA,
metrics that quantify operational characteristics of the particular RIA, and
counts related to disciplinary violations by the particular RIA.

In still another embodiment, the at least one additional artifact for the particular RIA can be derived by application of rules that involve one of conditional statements, weightings and rules for exceptional cases.

The data processing system can be further configured to identify affiliations between RIAs to define groups of RIAs, and derive additional artifacts that pertain to the groups of RIAs. The data processing system can derive additional artifacts for a given group of RIAs based upon artifacts and/or additional artifacts for each one of the RIAs of the given group. The data processing system can also derive additional artifacts for a given group of RIAs by applying rules that combine artifacts and/or additional artifacts for each one of the RIAs of the given group. The groups of RIAs can each include at least one RIA that advises on alternative investments having one or more private funds.

The data processing system can be further configured to calculate metrics that pertain to operational characteristics of business entities over time. Such business entities can be individual RIAs, groups of affiliated RIAs, peer groups of RIAs, and/or service providers.

The data processing system can be further configured to perform roll-up calculations for the metrics that pertain to operational characteristics of business entities. The rollup calculations of metrics can be performed over peer groups of business entities to provide benchmark metrics for the peer groups. Such business entities can be individual RIAs, groups of affiliated RIAs, and service providers. The benchmark metrics can be related to certain subject areas, including (i) expense practices, (ii) operational performance (productivity or work metrics), (iii) headcount efficiency, (iv) complexity of business, (v) conflicts of interest disclosed, (vi) regulatory history, (vii) executive staff turnover, (vii) consistency of form ADV filings, (ix) compliance of form ADV filings, and (x) service provider market share.

In still another embodiment, data stored in the second database is published to a third database that is accessed by users for querying and/or analysis. The querying and analysis of the data stored in the third database can provide for at least one of scenario-based analysis, time-series analysis, trend analysis and other modeling techniques for the data stored in the third database. Analysis of data stored in the third database can involve monitoring of user-defined alert conditions with respect to the data stored in the third database as well as communication of related alert messages.

In yet another embodiment, the data stored in the second database can be processed to identify artifacts and additional artifacts of interest that are integrated into a periodic communication for communication to users.

### BRIEF DESCRIPTION OF THE DRAWINGS

FIG. 1 is a high-level functional block diagram of a system for deriving and managing RIA knowledge according to the present disclosure.

FIGS. 2A, 2B and 2C, collectively, is a flow chart illustrating a workflow of data processing operation carried out by the system of FIG. 1 according to an illustrative embodiment of the present disclosure.

FIG. 3 is a flow chart illustrating an exemplary data collection methodology carried out by the system of FIG. 1 as part of the workflow of FIGS. 2A, 2B and 2C.

FIG. 4 is a flow chart illustrating an exemplary ADV form processing methodology carried out by the system of FIG. 1 as part of the workflow of FIGS. 2A, 2B and 2C.

FIGS. 5A, 5B, 5C and 5D illustrate exemplary database tables that store artifact data and additional artifact data generated by the system of FIG. 1 as part of the workflow of FIGS. 2A, 2B and 2C.

FIGS. 6A, 6B, 6C1, 6C2, 6D1, 6D2-1, 6D2-2, 6E, 6F1, 6F2, 6F3, 6F4 and 6F5 illustrate exemplary graphical user interfaces for user querying and analysis of artifact data and additional artifact data generated by the system of FIG. 1 as part of the workflow of FIGS. 2A, 2B and 2C.

### DETAILED DESCRIPTION OF THE PREFERRED EMBODIMENTS

As used herein, the term “RIA knowledge” means knowledge pertaining to RIAs as well as knowledge pertaining to entities and/or personnel that are affiliated with or otherwise related to RIAs.”

The embodiment of the present invention presented herein provides users with “useful” information on RIAs. “Useful” information is defined as information that can be original, less expensive, more timely, accurate and relevant than what a user could create for themselves. Original information, for the purposes of this application, means information that goes beyond the information reported by RIAs in their Form ADV filings and other publically available data sources. Such original information can be derived by combining multiple pieces of information and/or from inference with respect to one or more pieces of information. For example, an artifact referred to herein as “non-investment professionals,” or NIP, is a system-derived value for a RIA that is determined by a specific business rule that calculates the difference between the Full Time Equivalents and Investment Professionals reported in Form ADV by the RIA and then applies various tests to ensure the derived value is correct. This can include system-generated cross-checks to the RIA website and other publicly available sources. Such “useful” information can help clients (including limited partners), counter-parties, business associates and others identity, measure and benchmark the investment and non-investment staff levels, business practices, fund expenses and operating risks between one or more RIAs with similar net returns. There is no system or methodology currently available to systematically collect, clean, structure, associate, aggregate, de-duplicate, benchmark, analyze and distribute data on RIAs such that end users may understand how efficiently an RIA is running its business. In particular, the system and methodology presented herein serves to dramatically improve the efficiency, accuracy, and completeness of the analytical due diligence process of an RIA of alternative investments and furthermore makes possible the type of analysis previously impossible that can help investor improve returns and reduce the risk and expense of investing in private funds.

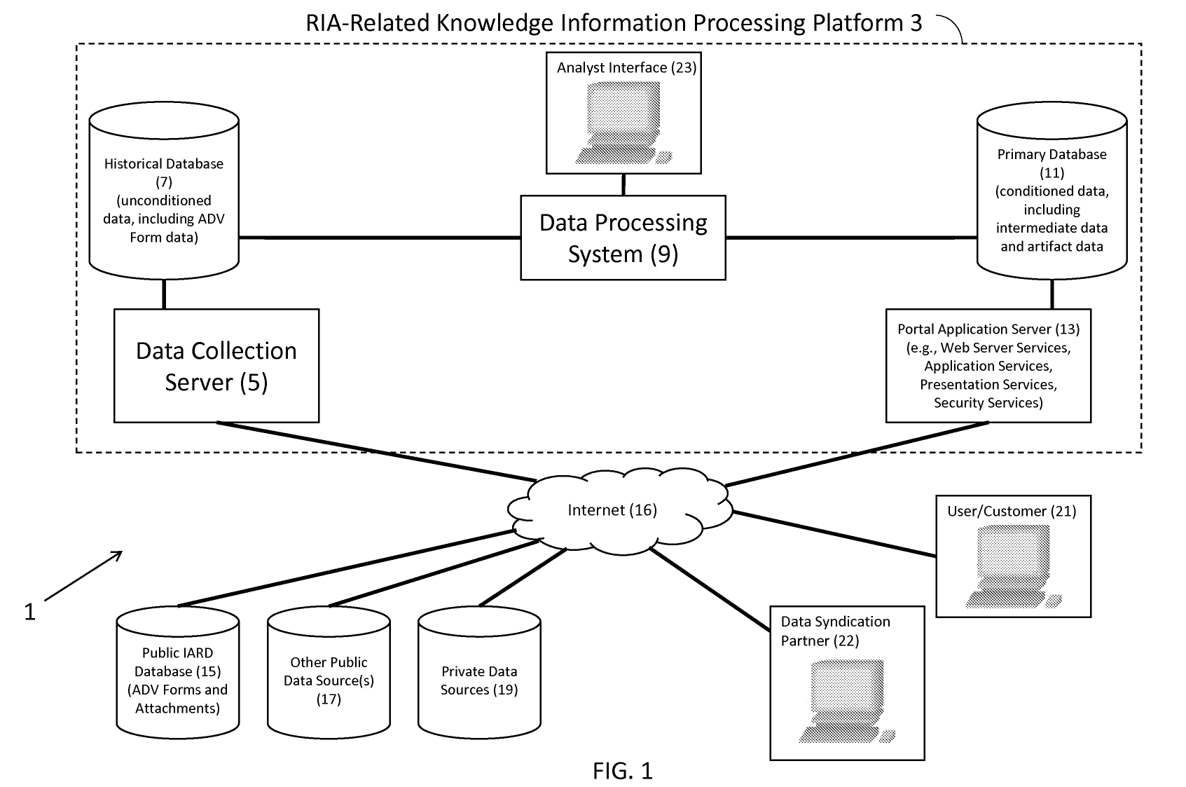

Turning now to FIG. 1, there is shown the system architecture of a distributed electronic system 1 according to the present disclosure. The system 1 collects and aggregates over time publicly-available information (and possibly private information) pertaining to RIAs and the investments (including alternative investments) that are recommended by such RIAs, processes the aggregated information to derive additional information that enhances the knowledge of such RIAs and associated investments beyond the knowledge found in the collected information, stores the aggregated information as well as the additional information that is generated over time in a database, and publishes the information stored in the database such that is made available to users of the system 1. The system 1 includes a service 3 (which is referred to in the drawings as “RIA-Related Knowledge Information Processing Platform”) having a data collection server 5, a historical database 7, a data processing system 9, a primary database 11, and a portal application server 13.

The data collection server 5 is a networked computer system that executes software that is configured to interact with the public IABD database 15 over the Internet 16 to retrieve copies of ADV forms that are made available to the public on a periodic (now daily) basis. The software of the data collection server 5 can also be configured to interact with other public data sources 17 and/or private data sources 19 over the Internet 16 in order to receive information pertaining to RIAs and their associated investments. In one example, the public data source 17 can include third-party alert services (such as the Google Alerts service, web crawling technology that matches a user-defined topic of interest, SEC news feeds, and/or third-party business networking services (such as the LinkedIn® service). Note that the data collection server 5 can interface to these services over the Internet 16 using a predefined messaging API to allow the data collection server 5 to retrieve information (such as current employer, current position, college history, etc.) and related to executive-level personnel listed in the collected ADV forms. The information collected by the data collection server 5 (including the retrieved ADV form data) is aggregated and stored as unconditioned data in the historical database 7.

The data processing system 9 is a computer system that executes software that is configured to process the unconditioned data stored in the historical database 7 (which represents the information aggregated and collected by the data collection server 5, including the retrieved ADV form data) to derive values for intermediate variables and artifacts that pertain to the RIAs businesses and the investments (including alternative investments). The artifacts are data items of interest that characterize useful pieces of information for RIAs and their related investments and their business practices (i.e., the way in which they manage their business). The business practices of an RIA can be defined by the data disclosed by the RIA in its ADV form filings, website or other documents and can be used by clients (including limited partners) and other interested parties to identify practices, expenses, staff levels, controls and risks employed by the RIA to generate investment returns. And the business practices of the RIAs can vary considerably between RIAs, particularly for alternative investments. For example, the business practices of an RIA can be described as “more complex than RIAs with similar investment strategies” if the subject RIA discloses a greater number of offshore affiliates, non-US limited partners, fund types, fund structures and regulators than their peer group. The intermediate data values and artifacts generated by the data processing system 9 are aggregated over time (as the underlying information is collected by the data collection server 5) and stored as conditioned data in the primary database 11.

The artifacts can relate to the RIAs themselves and can be derived directly from the information contained in the unconditioned data (e.g., ADV form data). For example, the artifacts can specify the legal name and business name of a respective RIA, the office location(s) of the respective RIA, foreign financial regulatory authorities that the respective RIA is subjected to, the number of employees of the respective RIA that perform advisory functions (referred to as “IP”) and the total number of employees of the respective RIA, the number and types of clients of the respective RIA, the dollar amount of regulated assets under management, including discretionary assets (referred to as “DiscRAUM”) and non-discretionary assets (referred to as “NonDiscRAUM”) and total assets (referred to as “RAUM”), entities that are related to the respective RIA, direct owners and indirect owners of the respective RIA, executive-level personnel of the respective RIA, and investment strategy of the respective RIA. These artifacts can be derived directly from the information contained in the ADV form data for the respective RIA.

The artifacts can also relate to the private funds advised by the RIAs and can be derived directly from the information contained in the unconditioned data (e.g., ADV form data). For example, the artifacts can specify, the name of the RIA of a respective private fund, the foreign financial regulatory authorities with which the respective private fund is registered, the fund structure (e.g., master, feeder, fund-of-funds) for the respective private fund, fund type for the respective private fund, and current gross asset value of the respective private fund. These artifacts can be derived directly from the information contained in the ADV form data for the respective RIA.

The artifacts can also relate to service providers (such as auditors, prime brokers, custodians, administrators, marketers) of a respective RIA and can be derived directly from the information contained in the ADV form data for the respective RIA.

The artifacts can also relate to disciplinary violations (including criminal, civil and regulatory violations) of a respective RIA and its affiliates and can be derived directly from the information contained in the ADV form data for the respective RIA.

The software of the data processing system 9 can be further configured to process the artifacts derived directly from the information contained in the ADV form data (and possibly other unconditioned data) to generate additional artifacts that enhance the knowledge of such RIAs and associated investments beyond the knowledge found in the information collected by the data collection server 5. The additional artifacts generated by the data processing system 9 are aggregated over time and stored as conditioned data in the primary database 11.

The additional artifacts can relate to metrics that are intended to quantify operational characteristics of RIAs, such as characteristics of business complexity, operating risk, employee count, fund and management company expenses, management fees, employee and work efficiency (e.g., IP/RAUM or total employees/RAUM). Such RIA metric artifacts can be derived over time in conjunction with statistical analysis (average, min, max) of the RIA metric artifacts over time.

The additional artifacts can also relate to groups of RIAs that are affiliated or controlled by a common entity (referred to herein as “Unique Manager Groups”). Such Unique Manager Groups are commonplace in asset management. For example, control entities set-up multiple RIAs to provide services to funds that have different strategies or reside in different jurisdictions. In many cases control entities file redundant information in the respective RIA ADV form filings that is difficult to resolve by human analysis. Without the contemplated invention, peer group analysis cannot be performed. Once a group of RIAs are associated with one another to form a Unique Manager Group, the related artifacts of the RIAs of a given Unique Manager Group can be combined and/or processed to derive system-generated additional artifacts for the given Unique Manager Group. For example, the artifacts representing the IP for the RIAs of a given Unique Manager Group can be combined and/or processed to form the additional artifact representing IP of the Unique Manager Group. The artifacts representing the NIP for the RIAs of a given Unique Manager Group can be combined and/or processes to form the additional artifact representing NIP of the Unique Manager Group. The artifacts representing the total employee count or the RIAs of a given Unique Manager Group can be combined and/or processed to form the additional artifact representing total employee count of the Unique Manager Group. The artifacts representing the RAUM for the RIAs of a given Unique Manager Group can be combined and/or processed to form the RAUM of the Unique Manager Group. The artifacts representing the DiscRAUM for the RIAs of a given Unique Manager Group can be combined and/or processed to form the DiscRAUM of the Unique Manager Group. The artifacts representing the NonDiscRAUM for the RIAs of a given Unique Manager Group can be combined and/or processed to form the NonDiscRAUM of the Unique Manager Group. The artifacts representing the office locations for RIAs of a given Unique Manager Group can be processed to identify the count of the number of office locations of the Unique Manager Group. The artifacts representing the funds for the RIAs of a given Unique Manager Group can be processed to identify the count of the number of funds for the Unique Manager Group. The artifacts representing the owners, administrators, auditors, brokers, custodians, marketers, and affiliates for the RIAs of a given Unique Manager Group can be processed identify the count of the number of owners, administrators, auditors, brokers, custodians, marketers, and affiliates for the Unique Manager Group. Certain artifacts of the RIAs of a given Manager Group can be processed to derive a Unique Manager Group artifact that characterizes a primary investment strategy type for the given Unique Manager Group. Certain artifacts of the RIAs of a given Unique Manager Group can be processed to derive a Unique Manager Group artifact that characterizes a dominant fund type for the given Unique Manager Group. Certain artifacts of the RIAs of a given Unique Manager Group can be processed to derive a Unique Manager Group artifact that characterizes the complexity for the given Unique Manager Group. Certain artifacts of the RIAs of a given Unique Manager Group can be processed to derive a Unique Manager Group artifact that characterizes the operating risk of the given Unique Manager Group. And certain artifacts of the RIAs of a given Unique Manager Group can be processed to derive a Unique Manager Group artifact that characterizes the level of consistent and inconsistent expense practices of the given Unique Manager Group.

The additional artifacts can also relate to metrics that are intended to quantify and trend the operational characteristics of Unique Manager Groups, such as characteristics of employee count, business complexity, expenses and expense practices, operating risks, revenue, employee headcount and work efficiency (e.g., IP/RAUM or total employees/funds). Such Unique Manager Group metric artifacts can be derived over time in conjunction with statistical analysis (average, min, max) of the Unique Manager Group metric artifacts over time.

The additional artifacts can also relate to peer groups of RIAs (and/or Unique Manager Groups) that share common characteristics, such as investment strategy, employee size, RAUM, or other suitable characteristics. In this case, the additional artifacts can specify benchmark metrics for the peer groups. The benchmark metrics for a given peer group can be derived by combining and/or processing the corresponding metric values for the RIAs (and/or Unique Manager Groups) of the given peer groups. Such peer group benchmark metric artifacts can be derived over time in conjunction with statistical analysis (average, min, max) of the peer group benchmark metric artifacts over time. Such peer group benchmark metric artifacts can be useful in evaluating the relative operational characteristics and expenses of a specific RIA (or Unique Manager Group) as compared to the others in the peer group and/or in searching for and identifying one or more RIAs or Unique Manager Groups that satisfy certain conditions or constraints with regards to the peer group benchmark metric artifacts.

One or more analyst interfaces (one shown as 23) can be configured to allow a human operator (analyst) to review the artifacts and additional artifacts generated by the system and possibly manually edit or remove or add artifacts and additional artifacts as needed based on human analysis of information contained in both the historical database 7 and the primary database 11.

The portal application server 13 is a networked computer system that executes software that is configured to publish the information represented by the artifacts stored as conditioned data in the primary database 11 to customers/users (one shown as 21). Such publication can involve operations that process the conditioned data to identify daily changes of interest (such as new private funds, significant change in RAUM, new affiliations and service provider relationships, changes in executive level personnel, and/or new regulatory violations). The information can be packaged into a daily communication that highlights such information for electronic delivery over the Internet 15 and consumption by user/customers. Such publication can also involve syndicating a limited part of the conditioned data stored in the primary database 11 to a third-party data syndication partner 22 (which can be a media channel such as Bloomberg or Reuters, a data reseller or other advisory business service providers) for delivery and/or access to downstream users/customers. Such publication can also involve copying a limited part of the conditioned data stored in the primary database to a live portal database for access by customer/users over the Internet 15. In this case, the portal application server 13 employs user permissions to control access and querying capability with respect to the live portal database, and user/customers can access and query the live portal database in order to perform analysis (e.g., scenario-based analysis, time-series analysis, trend analysis and other modeling techniques) of the information represented by the artifacts stored as conditioned data in the primary database 11. Such analysis can also involve calculation of user-defined metrics and user-defined benchmark metrics on the information represented by the artifacts stored as conditioned data in the primary database 11. Such analysis can also involve monitoring of user-defined alert conditions with respect to the information represented by the artifacts stored as conditioned data in the primary database 11 as well as communication of related alert messages.

The software resources of the portal application server 13 can also include a live portal database system, web server services, application services, presentation services and security services. The presentation services is a facility that enables delivering dynamic content to the user/customer machines 11. Preferably, the presentation services support Active Server Pages, JavaServer pages, server-side scripting such as PHP, Ruby, Perl, CGI, PL/SQL scripting, etc. Preferably, the portal application server 13 is realized by a commercially-available software system, such as the Linux, Apache or JBoss platform, the Websphere Application Server commercially available from IBM Corp., Windows Server Systems commercially available from Microsoft Corp., the Weblogic Server platform commercially available from Oracle Corp., or similar platforms.

The data processing functionality of data collection server, historical database 7, data processing system 9, primary database 11, and the portal application server 13 can be realized on one or more data processing platforms. The data processing platforms can be implemented as separate data processing platforms, multiple virtual machines executing on a single data processing platform, and/or combinations thereof. Inter-process communication mechanisms (such as sockets, pipes, shared memory, message queues and message passing).

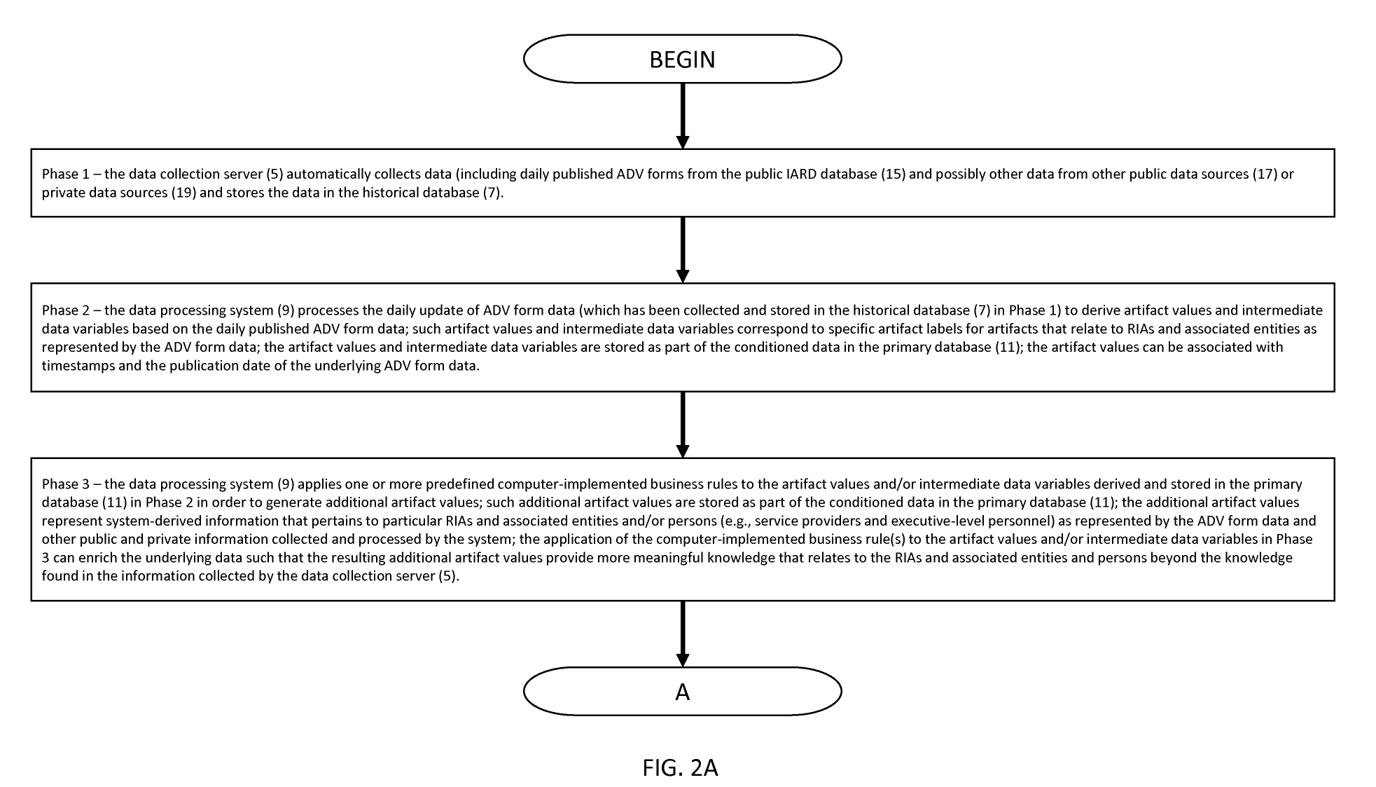

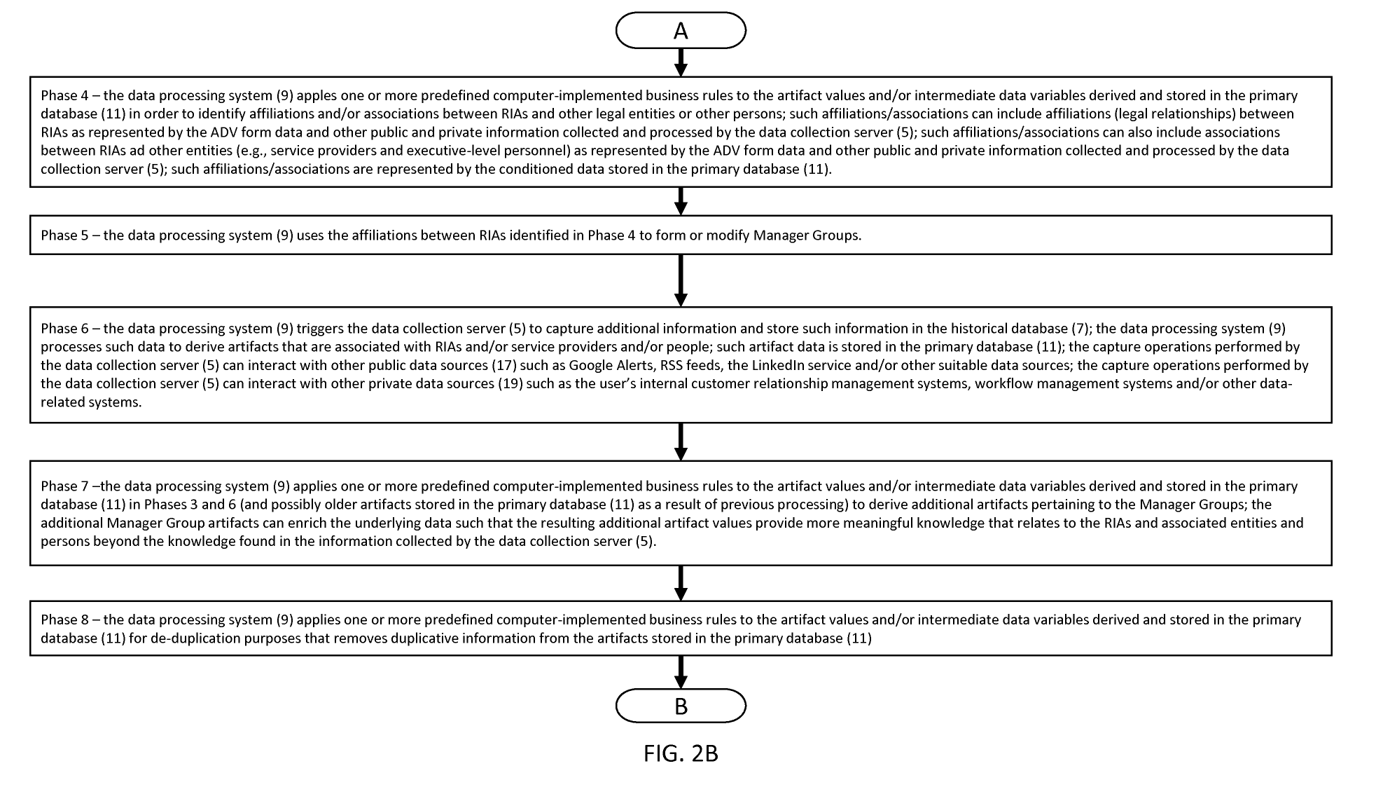

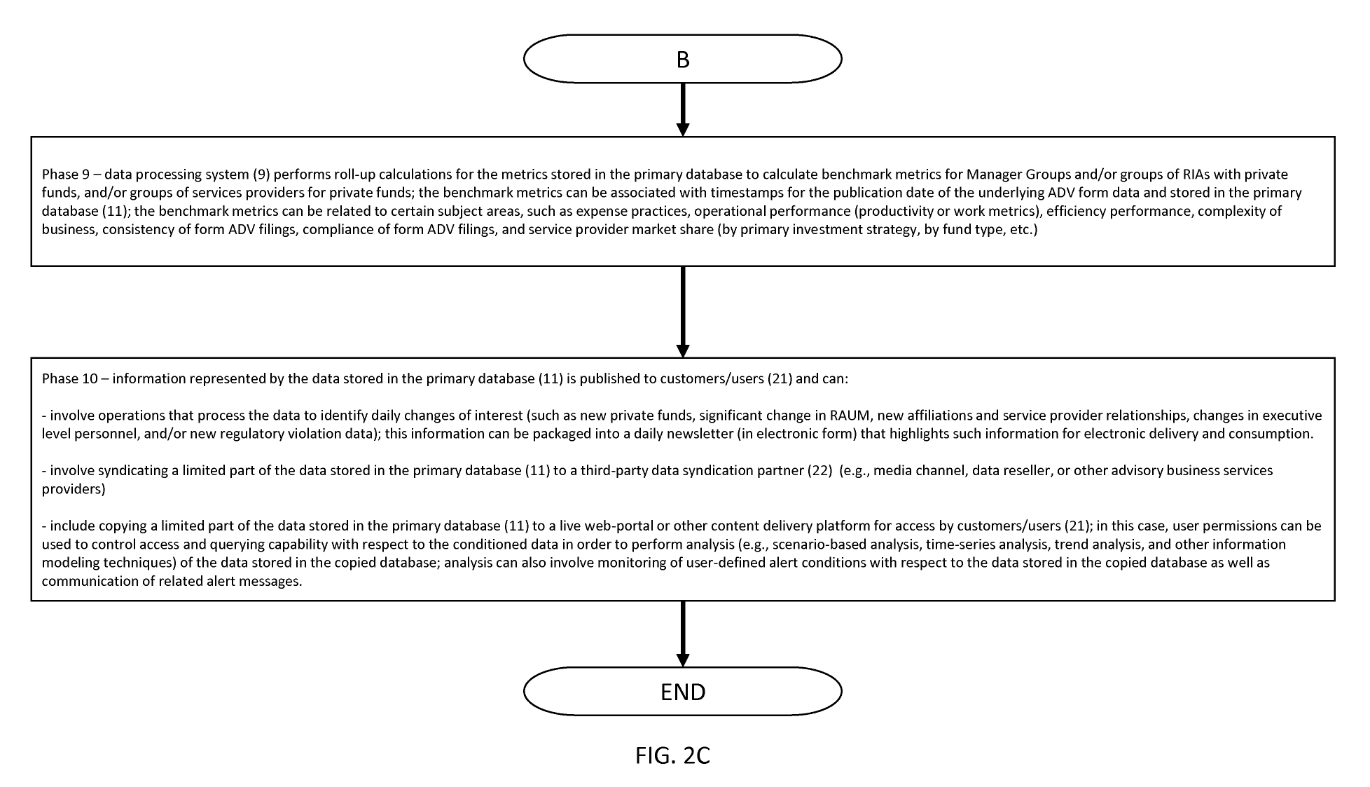

In one embodiment, the operations of the system 1 of FIG. 1 can be logically organized as a workflow of phases illustrated in the flowchart of FIGS. 2A-2C. In phase 1, the data collection server 5 automatically collects data (including daily-published ADV forms) from the public IABD database 15 and possibly other data from other public data sources 17 and/or private data sources 19, and stores the data (unconditioned data) in the historical database 7.

In phase 2, the data processing system 9 processes the daily update of ADV form data (which has been collected and stored as unconditioned data in the historical database 7 in Phase 1) to derive artifact values and intermediate data variables based on the daily-published ADV form data. Such artifact values and intermediate data variables can correspond to specific artifact labels for artifacts that relate to RIAs and associated entities as represented by the ADV form data. The artifact values and intermediate data variables are stored as part of the conditioned data in the primary database 11. The artifact values can be associated with data source identifiers and timestamps for the publication date of the underlying ADV form data as well as for each processing phase (e.g., enrichment) performed by the system.

The artifact values and intermediate data variables derived in phase 2 can relate to the RIAs themselves and can be derived directly from the information contained in the unconditioned data (e.g., ADV form data).

For example, the artifact values derived in phase 2 can be related to a particular RIA as reported in one or more ADV form filings. Examples include:
knowledge date (from ADV publication date);
Legal Name (from Item 1A);
Business Name (from Item 1B and Schedule D);
SEC Number (from Item 1D);
address and telephone and fax information for principal office and place of business (from Items 1F and 1G and Schedule D);
financial regulatory authorities (from Item 1M and Schedule D);
number of employees of the RIA, including IP and the total number of employees (from Items 5A and 5B);
number and types of clients (from Items 5C and 5D1);
amount of regulatory assets under management for different types of clients (from Item 5D2);
regulated assets under management, including DiscRAUM, NonDiscRAUM and RAUM (from Item 5F);
type of advisory services provided, such as Financial planning services, Portfolio management for individuals and/or small businesses, Portfolio management for investment companies etc. (from Item 5G);
information regarding wrap fee programs (from Item 5I and Schedule D);
information regarding other business activities (from Item 6 and Schedule D);
information about financial industry affiliations and activities (from Item 7 and Schedule D);
information about participation and interest in client transactions (from Item 8);
direct owners and executive officers (from Items 1J and 1K and Schedules A and C); and
indirect owners (from Schedules B and C).

The artifact values and intermediate variables derived in phase 2 can also relate to the private funds advised by the RIAs and can be derived directly from the information contained in the unconditioned data (e.g., ADV form data). Examples include:
the name of the RIA or Unique Manager Group of a particular private fund;
the foreign financial regulatory authorities with which the particular private fund is registered;
the fund structure (e.g., master, feeder, fund-of-funds) for the particular private fund;
current gross asset value of the particular private fund;
ownership information of the particular private fund; and
service providers (such as auditors, brokers, custodians, administrators, marketers) for the particular private fund.
   These artifacts can be derived directly from the information contained in the Schedule D of the ADV form data.

The artifact values and intermediate variables derived in phase 2 can also relate to service providers (such as auditors, brokers, custodians, administrators, marketers) of a particular RIA and can be derived directly from the information contained in the ADV form data for the particular RIA.

The artifact values and intermediate variables derived in phase 2 can also relate to disciplinary violations (including criminal, civil and regulatory violations) of a particular RIA and its affiliates and can be derived directly from the information contained in the ADV form data for the particular RIA (specifically from Item 11 and the reporting pages for criminal, regulatory and civil actions).

The artifact values and intermediate variables derived in phase 2 can also relate to a particular executive or control person. Examples include:
knowledge date;
name of the particular executive or control person;
month and year of hire of the particular executive or control person;
title of the particular executive or control person;
equity ownership level of the particular executive or control person;
registered SEC number of the particular executive or control person; and
information identifying the RIA (or Unique Manager Group) that employs the particular executive or control person.

In phase 3, the data processing system 9 applies one or more predefined computer-implemented business rules to the artifact values and/or intermediate data variables derived and stored in the primary database 11 in phase 2 in order to generate additional artifact values. Such additional artifact values are stored as part of the conditioned data in the primary database 11. The additional artifact values represent system-derived information that pertains to particular IRAs and associated entities and/or person (e.g., service providers and executive-level personnel) as represented by the ADV form data and other public and private information collected and processed by the system. The application of the computer-implemented business rule(s) to the artifact values and/or intermediate data variables in phase 3 can enrich the underlying data such that the resulting additional artifact values provide useful information that relates to the RIAs and associated entities and persons beyond the knowledge found in the information collected by the data collection server 5.

Examples of the additional artifacts derived in phase 3 include:
number of employees that do not perform investment advisory functions (referred to as “NIP”, which is calculated by subtracting the reported IP from the reported total number of employees) for a particular RIA;
total value of private funds managed by the particular RIA (referred to as “PFRAUM”);
count of total number of private funds managed by the particular RIA;
metrics that quantify operational characteristics of the particular RIA, such as characteristics of employee count, employee work efficiency (e.g., IP/RAUM or total employees/RAUM), expense efficiency (expenses/RAUM), and risk v return metrics; such RIA metric artifacts can be derived over time in conjunction with statistical analysis (average, min, max) of the RIA metric artifacts over time for the particular RIA;
counts related to disciplinary violations by the particular RIA and affiliates;
dominant fund type of the particular RIA (e.g., hedge fund, liquidity fund, private equity fund, real estate fund, securitized asset fund, venture capital fund, other funds);
primary investment strategy of the particular RIA; this artifact can be assigned from one a number predefined types (such as Real Estate, Equity, Emerging Markets, Private Equity, Mutual Funds, Quantitative Trading, Multi-Strategy and Fund of Funds, etc.); and
one or more categories of expenses (referred to herein as “expense practice categories”) that are allocated as charges, fees or expenses payable by investors of the private fund(s) advised by the particular RIA as disclosed in the ADV form data filed by the particular RIA.

The business rules that derive the additional artifacts derived in phase 3 can include conditional statements, weightings and/or rules for exceptional cases that are configured to assign a value to a particular additional artifact that is best reflected by corresponding reported artifacts and/or intermediate data values. The business rules can be configured to perform data hygiene processing where equivalent values are mapped to a predefined artifact value. The business rules can be organized such that one business rule corresponds to a particular additional artifact (one-to-one correspondence between business rules and additional artifacts), multiple business rules correspond to a particular additional artifact (many-to-one correspondence between business rules and additional artifacts), and/or one business rule corresponds to many additional artifacts (one-to-many correspondence between business rules and additional artifacts).

For example, an additional artifact that specifies the dominant fund type of a particular RIA can be derived by applying business rules to the intermediate data values that correspond to particular fields in Question 10 of Section 7.B.(1)) of part 1A of the form ADV data.

In another example, an additional artifact that specifies the primary investment strategy of a particular RIA can be derived by parsing and semantic analysis of the section of the Brochure that generally describes the advisory services provided by the particular RIA to generate a set of matrix scores (intermediate data values) that relate to the predefined types of investment strategies, including but not limited to i) equity, ii) debt-diverse, iii) debt-distress, iv) multi-strategy, v) emerging markets, vi) frontier markets, vii) commodities, viii) real estate, ix) private equity, x) venture capital, xi) quantitative trading, xii) limited partnership interests, xiii) legal claims, xiv) securitized asset funds, xv) mutual funds, xvi) film rights, xvii) fund of funds, xix) insurance-linked securities, xx) consulting, xxi) small business lending, xxii) managed account and xxiii) exchange-traded funds. Business rules analyze the matrix scores to identify one of the predefined types that best matches the advisory services described in the Brochure, and the type for the highest matrix score is assigned to the primary investment strategy of the particular RIA.

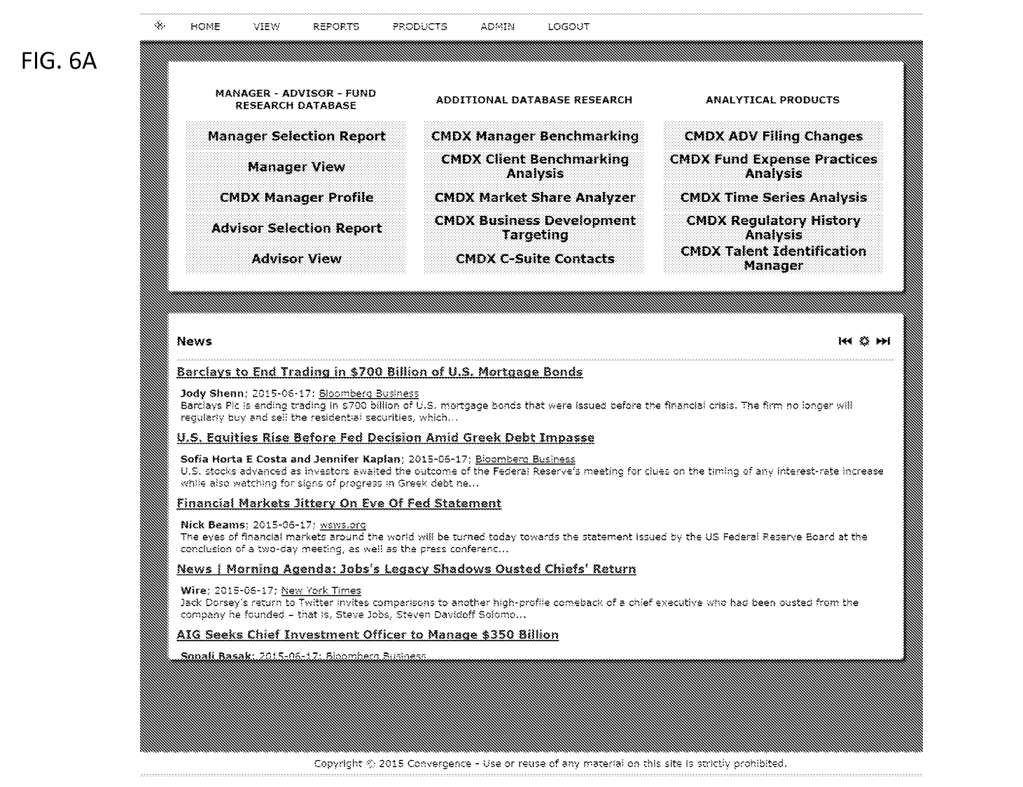

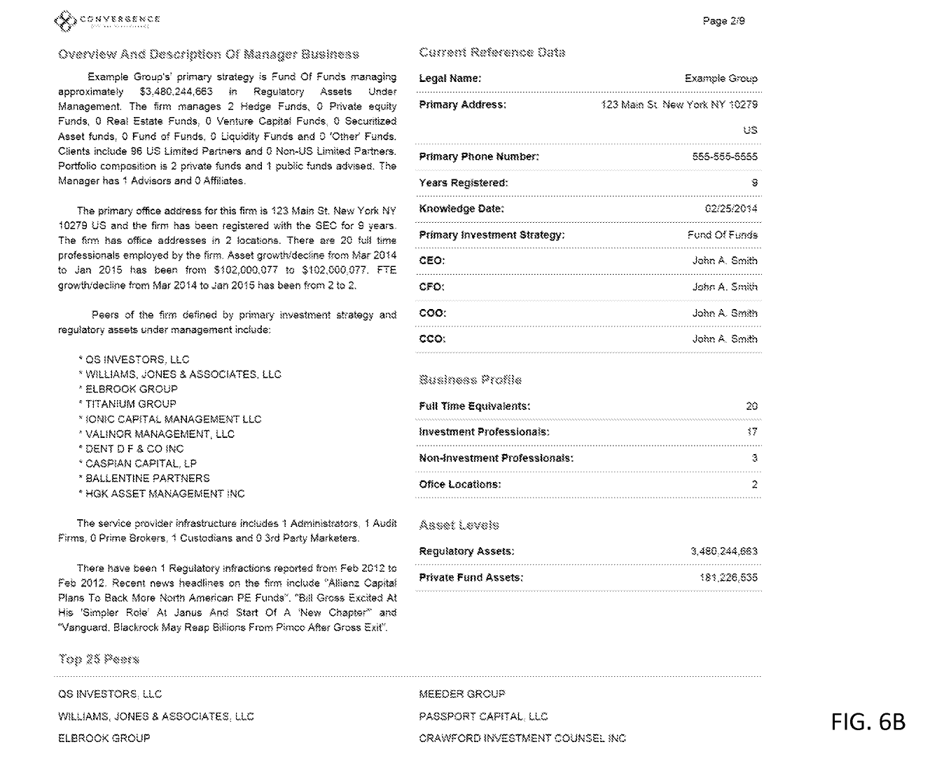

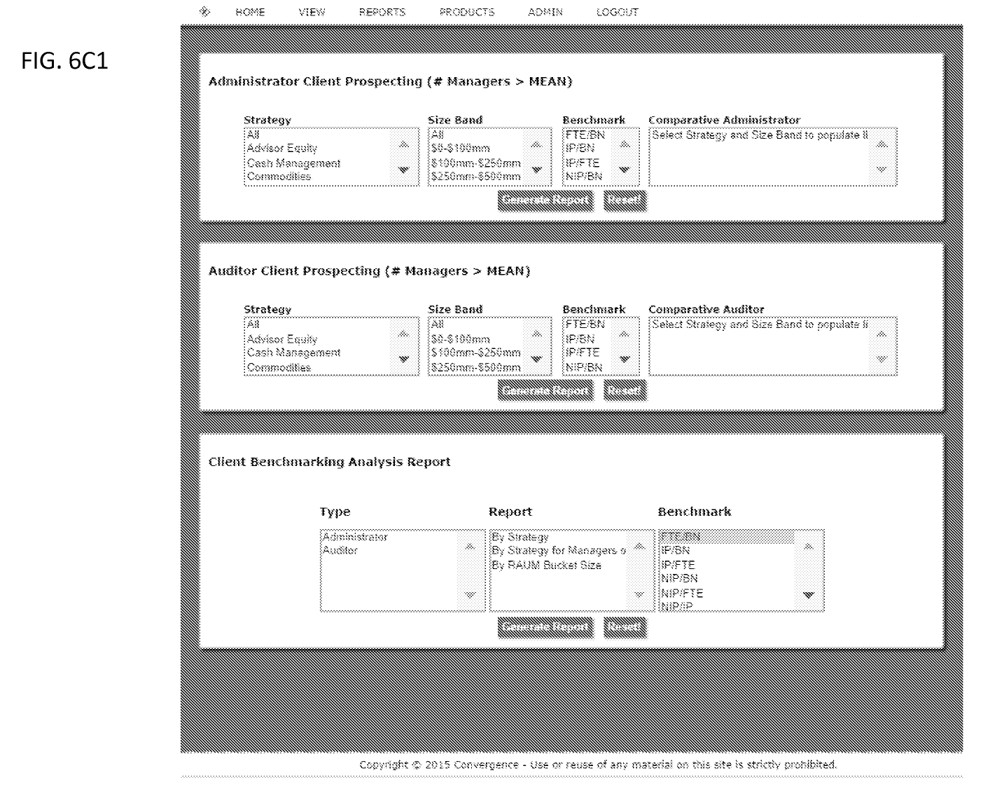

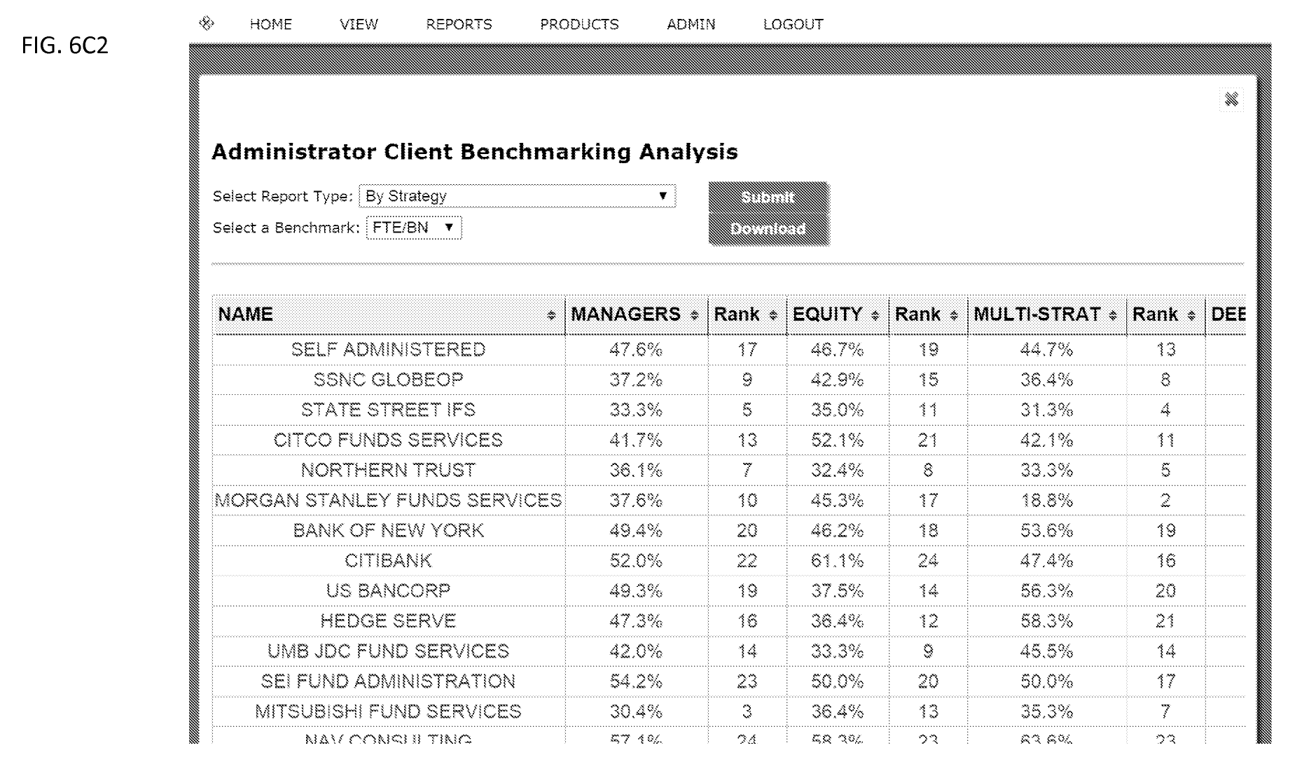

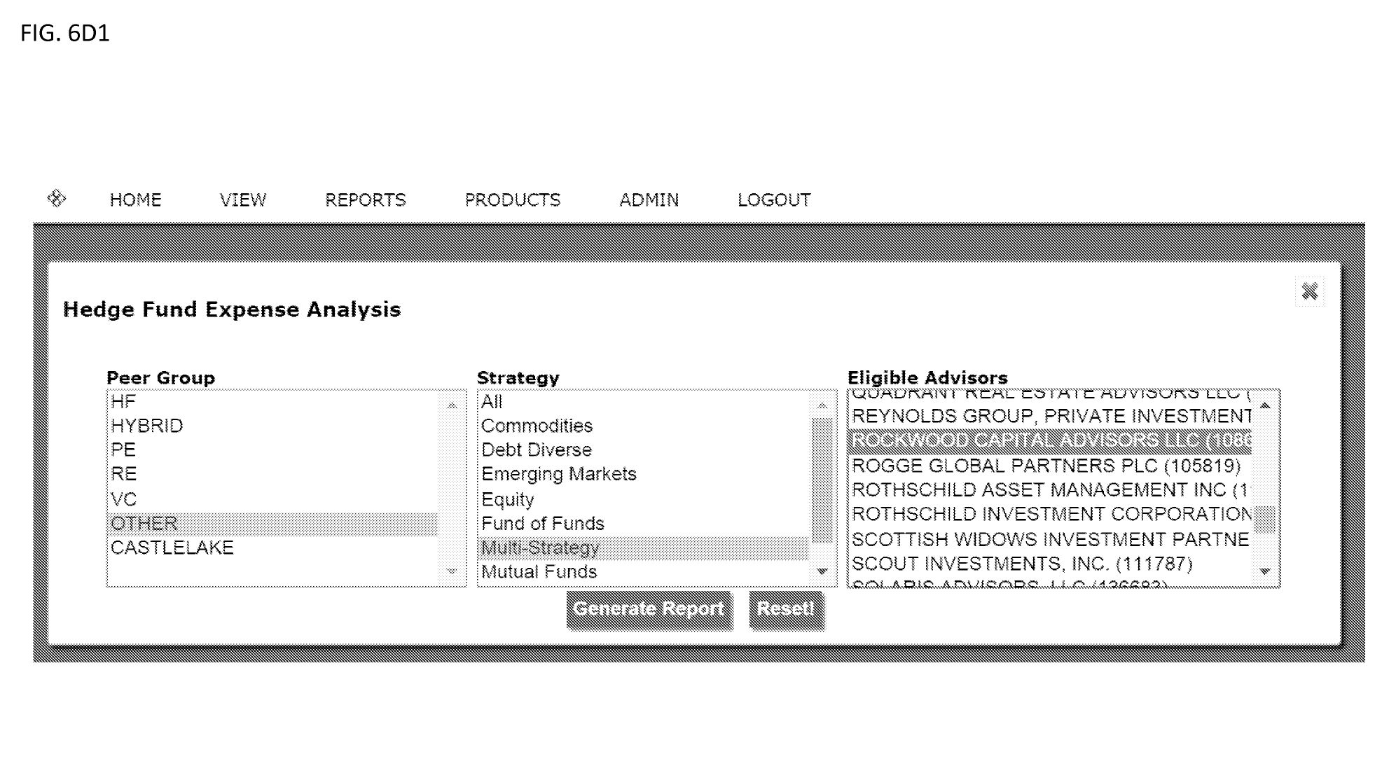

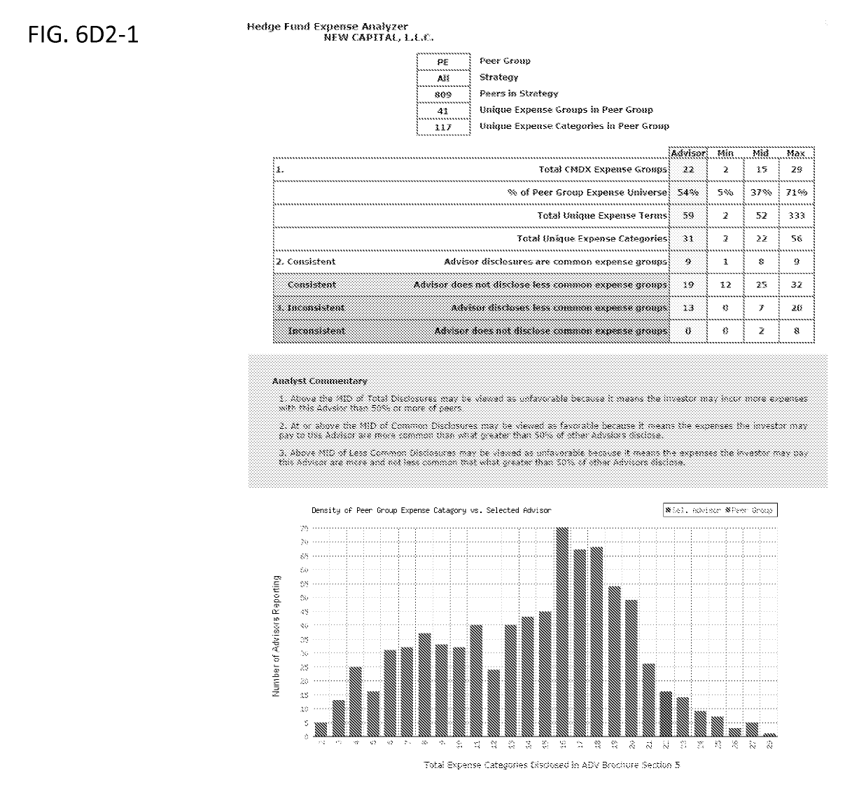

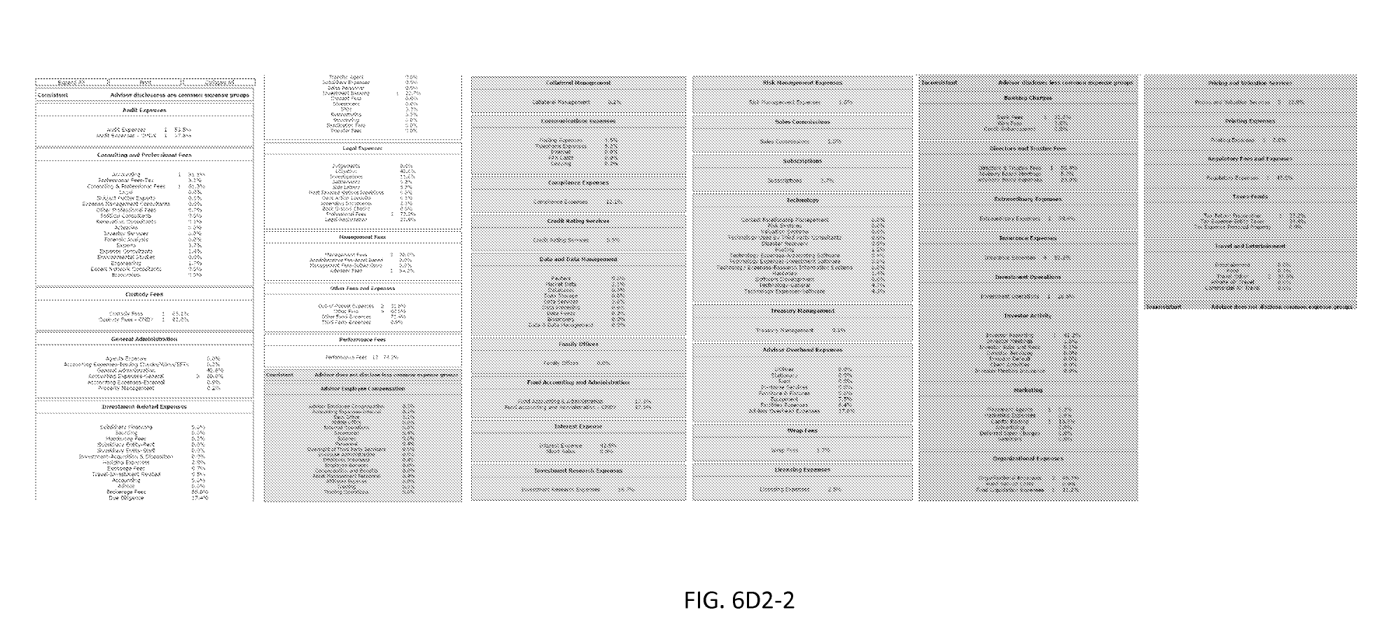

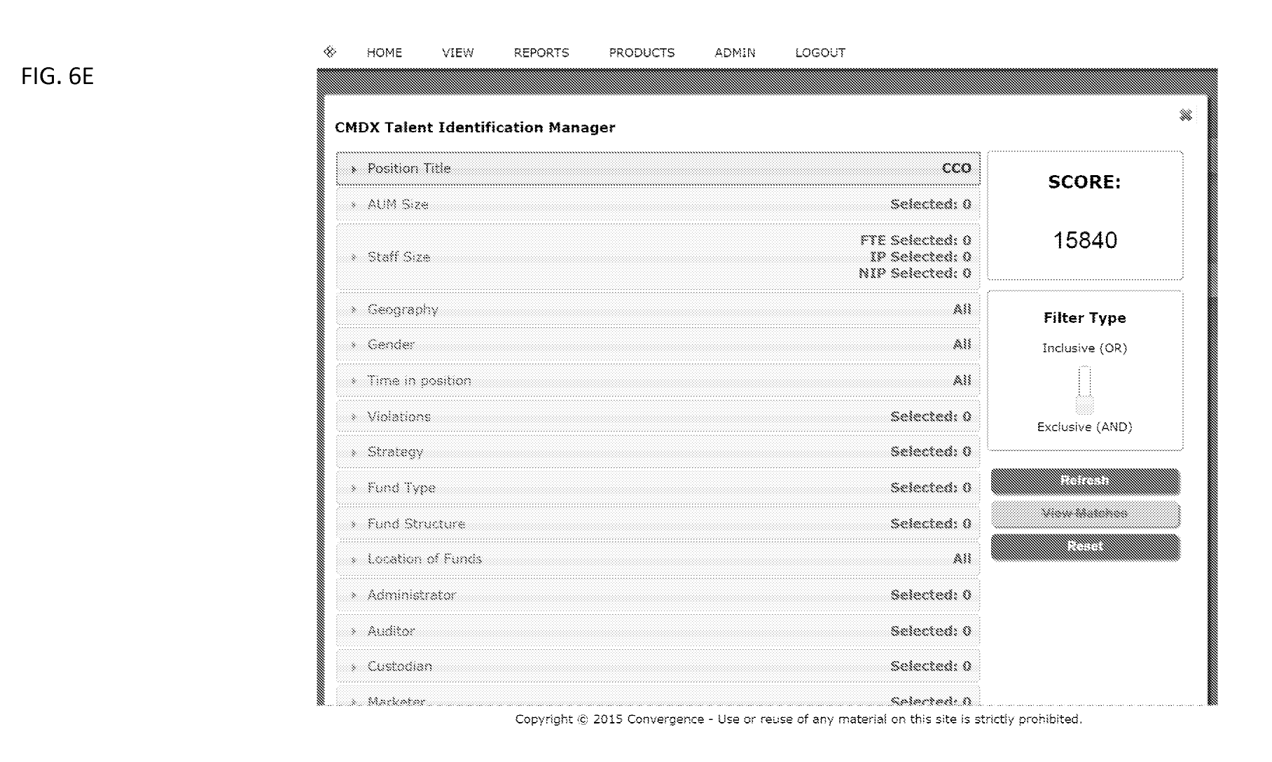

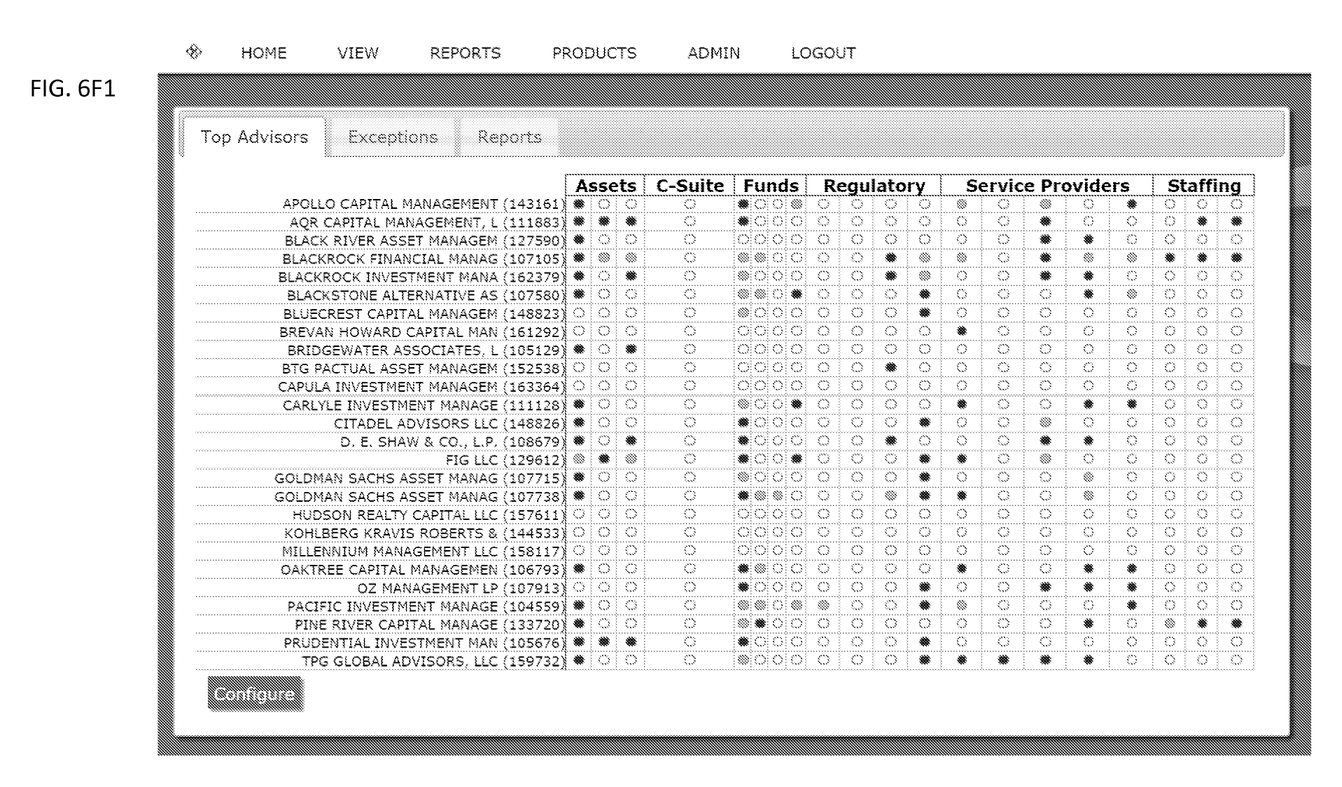

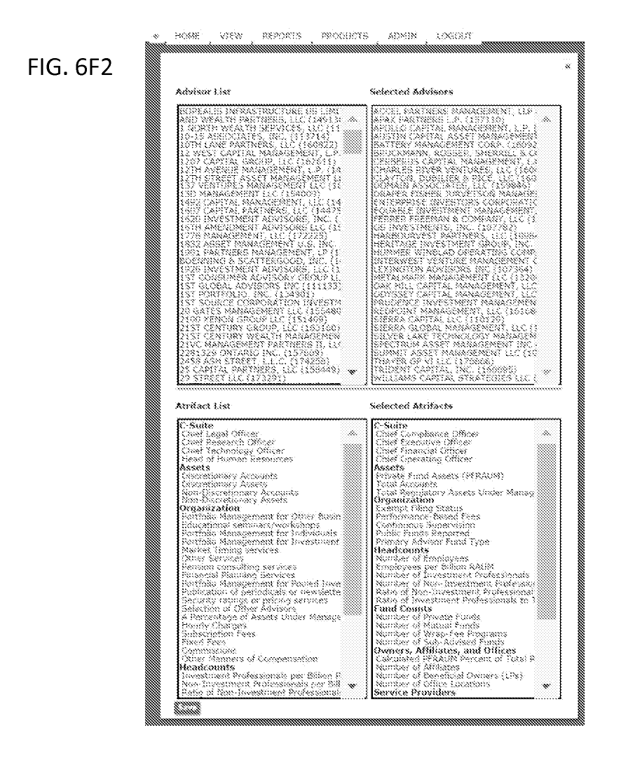

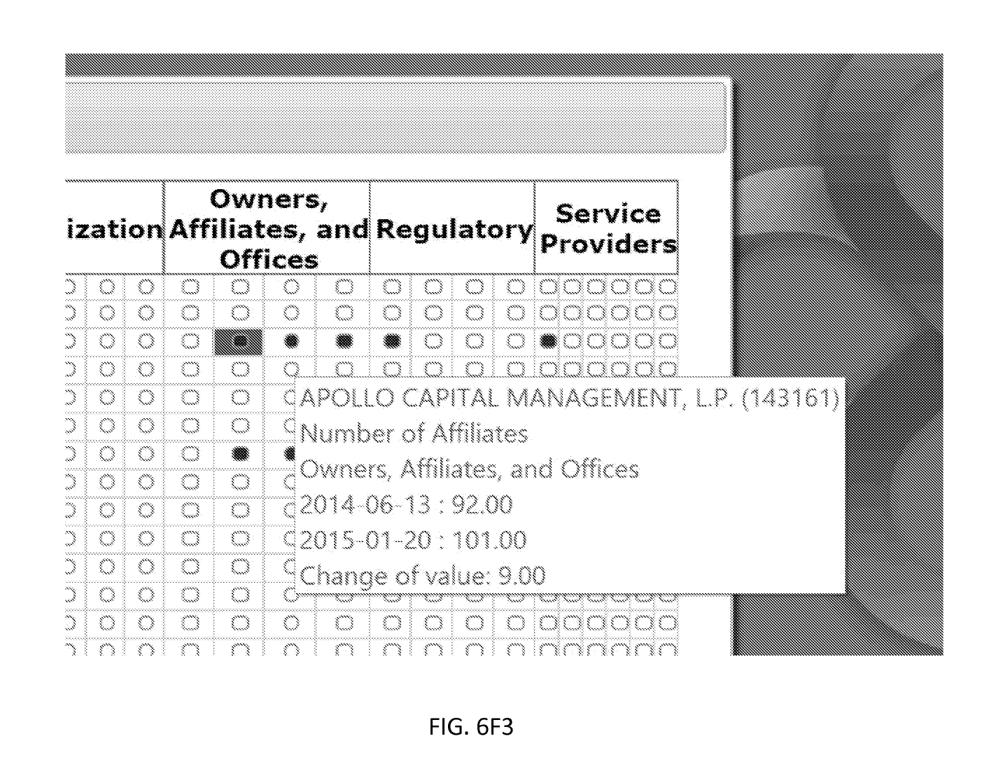

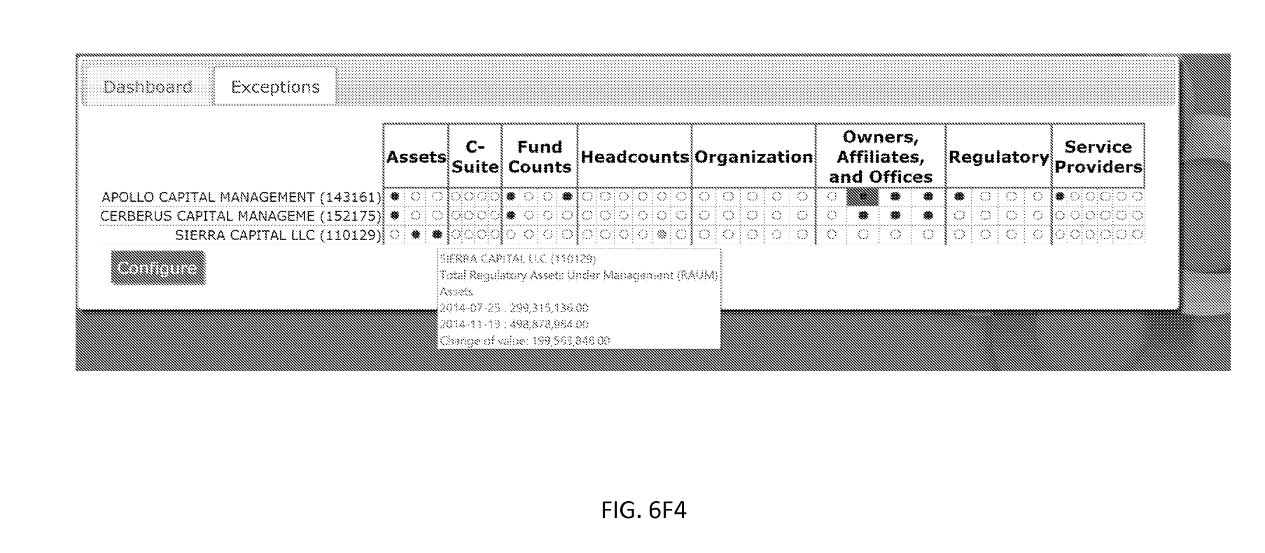

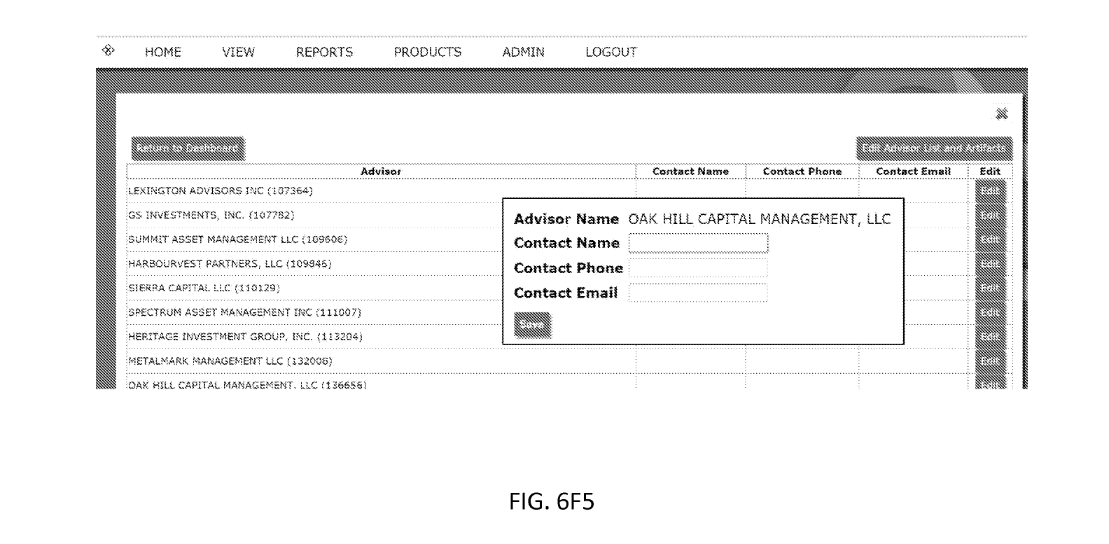

In yet another example, one or more additional artifacts that specify an expense practice category of a particular RIA can be derived by parsing and semantic analysis of the section of the Brochure that generally describes the fees and compensation provided by the particular RIA to generate a set of matrix scores (intermediate data values) that relate to the predefined types of expense practice categories. Examples of such expense practice categories is shown and described below with respect to FIG. 6D3. Business rules analyze the matrix scores to identify one of the predefined types that best matches the expense practice categories described in the Brochure, and the type(s) for the highest matrix score(s) is/are assigned to the expense practice category(ies) of the particular RIA.

In yet another example, an additional artifact that specifies the PFRAUM of a particular RIA can be derived by business rules that combine and/or process data values (intermediate data) that correspond to fields of Question 11 within Section 7.B.(1)) of part 1A of the form ADV data. For the case that a private fund is organized as a master fund that is fed by one or more feeder funds, the business rules can derive PFRAUM of a particular RIA as the net of system identified duplicative feeder fund values.

In phase 4, the data processing system 9 applies one or more predefined computer-implemented business rules to artifacts stored in the primary database 11 in order to identify affiliations (legal relationships dictated by control) between RIAs as well as other associations between RIAs and other legal entities or other persons. For affiliations between RIAs, such affiliations can be identified by equivalency matching of assets, staff levels, executive level staff, complexity scores, entity names, common control and/or ownership entities, business addresses, web domain registrations, and telephone numbers and other contact data for artifact values that represent affiliations with controlling interests as part of the conditioned data in the primary database. For an association between a respective RIA and a services provider, such association can be identified by equivalency matching of entity names for artifact values that represent service providers that provide service to the respective RIA. For association between a respective RIA and an executive, such association can be identified by equivalency matching of entity names for artifact values that represent executives of the respective RIA. The affiliations and/or associations derived in phase 4 are represented by conditioned data stored in the primary database 11.

In phase 5, the data processing system 9 uses the affiliations between RIAs identified in phase 4 to form or modify Unique Manager Groups. In one embodiment, a Unique Manager Group includes a grouping of one RIA or multiple affiliated RIAs where at least one RIA of the grouping advises on one or private funds. Note that the RIA(s) of a Unique Manager Group can advise on both public fund(s) and private fund(s). And the RIA(s) of a Unique Manager Group can advise on only public funds when other RIA(s) of the Unique Manager Group advise on one or more private funds. The Unique Manager Groups are represented by conditioned data stored in the primary database 11. Such Unique Manager Groups are commonplace in alternative investments that employ complex fund structures. For example, in a master-feed fund structure where a number of Feeder Funds feed a Master Fund, the RIAs of the Master and Feeder Funds are typically affiliated with one another and can be viewed as a Unique Manager Group.

In phase 6, the data processing system 9 triggers the data collector server 5 to capture additional information and store such information in the historical database 7. The data processing system 9 processes such data to derive artifacts that are associated with particular RIAs and/or Unique Manager Groups and/or Service Providers and/or people. Such artifact data is stored in the primary database 11. The capture operations performed by the data collection server can interact with third party data sources, such as third party alert services, SEC RSS feeds, third party business network services and/or other suitable data sources in order to derive useful artifacts pertaining to particular RIAs and/or Unique Manager Groups and/or Service Providers and/or people that supplements the knowledge derived from the ADV form data.

In phase 7, the data processing system 9 applies computer-implemented business rules to the artifacts stored in the primary database 11 in Phase 3 and 6 (and possibly as older artifacts stored in the primary database as a result of previous processing) to derive additional artifact values pertaining to the Unique Manager Groups. Such Unique Manager Group artifact values enrich the underlying data by providing useful information that relates to the affiliated RIAs of the Manager Groups beyond the knowledge found in the information collected by the data collection server 5.

Examples of Unique Manager Group Artifacts include:
knowledge date;
DiscRAUM, NonDiscRAUM, and RAUM for a particular Unique Manager Group;
the number of employees, including IP and NIP for the particular Unique Manager Group;
PFRAUM for the particular Unique Manager Group;
count of total number of private funds for the particular Unique Manager Group;
count of offices of the particular Unique Manager Group;
count of affiliated Service Providers of the particular Unique Manager Group; including count of affiliated Administrators, count of affiliated Auditors, count of affiliated Custodians, count of affiliated Brokers, count of affiliated Marketers;
count of foreign financial regulatory authorities for the particular Unique Manager Group;
count of disciplinary violations by RIAs and affiliates of the particular Unique Manager Group; the counts can be by type of violation, criminal, civil, regulatory
primary investment strategy for the particular Unique Manager Group;
useful metrics for benchmarking the Unique Manager Group; for example, the metrics can track statistics (such min, max and average) of a given artifact (such as FTE, IP, NIP, RAUM, PFRAUM, fund count, foreign financial regulatory authority count, disciplinary violation count, etc.) over time as well as statistical variables (deltas) associated therewith; and
information identifying primary service providers (e.g., Administrators, Auditors, Custodians, Brokers, Marketers with the largest share of respective business) for the RIAs of the Unique Manager Group.

The business rules that derive the Unique Manager Group artifacts can combine the related artifact values of the RIAs of a given Unique Manager Group. For example, the artifacts representing the IP for the RIAs of a given Unique Manager Group can be combined and/or processed to form the additional artifact representing IP of the Unique Manager Group. The artifacts representing the NIP for the RIAs of a given Unique Manager Group can be combined and/or processes to form the additional artifact representing NIP of the Unique Manager Group. The artifacts representing the total employee count or the RIAs of a given Unique Manager Group can be combined and/or processed to form the additional artifact representing total employee count of the Unique Manager Group. The artifacts representing the RAUM for the RIAs of a given Unique Manager Group can be combined and/or processed to form the RAUM of the Unique Manager Group. The artifacts representing the DiscRAUM for the RIAs of a given Unique Manager Group can be combined and/or processed to form the DiscRAUM of the Unique Manager Group. The artifacts representing the NonDiscRAUM for the RIAs of a given Unique Manager Group can be combined and/or processed to form the NonDiscRAUM of the Unique Manager Group. The artifacts representing the office locations for RIAs of a given Unique Manager Group can be processed to identify the count of the number of office locations of the Unique Manager Group. The artifacts representing the funds for the RIAs of a given Unique Manager Group can be processed to identify the count of the number of funds for the Unique Manager Group. The artifacts representing the owners, administrators, auditors, brokers, custodians, marketers, and affiliates for the RIAs of a given Unique Manager Group be processed identify the count of the number of owners, administrators, auditors, brokers, custodians, marketers, and affiliates for the Unique Manager Group.

The business rules that derive the Unique Manager Group artifacts can include conditional statements, weightings and/or rules for exceptional cases that are configured to assign a value to a particular Unique Manager Artifact that is best reflected by corresponding artifacts of the RIAs that belong to the particular Unique Manager Group. The business rules can be configured to perform data hygiene processing where equivalent values are mapped to a predefined artifact value. For example, for the case where a service provider's name is commonly spelled in different ways, the different spells can be mapped to a predefined spelling for the artifact value. The business rules can be organized such that one business rule corresponds to a particular unique Manager Group artifact (one-to-one correspondence between business rules and Unique Manager Group artifacts), multiple business rules correspond to a particular Unique Manager Group artifact (many-to-one correspondence between business rules and Unique Manager Group artifacts), and/or one business rule corresponds to many Unique Manager Group artifacts (one-to-many correspondence between business rules and Unique Manager Group artifacts).

The business rules can examine these data values to identify possible cases of redundancy and compensate for these cases. Consider one example where the same office location is reported for more than one RIA of a given Unique Manager Group. In this case, the count of the number of office locations of the Unique Manager Group is adjusted to count this same office location just once. Consider another example where the same fund is reported for more than one RIA of a given Unique Manager Group. In this case, the count of the number of funds of the Unique Manager Group is adjusted to count this same fund just once. Consider yet another where multiple RIAs report redundant values of PFRAUM, which is common in master-feeder structures where one fund is a feeder for another fund. In this case, the value of the Feeder Fund is redundant as it is reflected in the value of the Master Fund. In another example, two affiliated RIAs may disclose the same fund. In considering the derivation of performance metrics (efficiency, productivity, complexity, etc.) for the individual RIAs, this one fund is counted twice. However, in considering the derivation of performance metrics (efficiency, productivity, complexity, etc.) for the Unique Manager Group, the fund is counted only once.

The business rules that derive the Unique Manager Group artifacts can also examine certain artifacts of the RIAs of a given Unique Manager Group to derive an additional artifact value that characterizes a primary investment strategy for the given Unique Manager Group. Specifically, the Unique Manager Group's primary investment strategy can be derived from the primary investment strategy representing the majority of the RAUM advised by the RIAs in the Unique Manager Group.

The business rules that derive the Unique Manager Group artifacts can also examine certain artifacts of the RIAs of a given Unique Manager Group to derive an additional artifact value that characterizes a dominant fund type for the given Unique Manager Group. Specifically, the dominant fund type for a Unique Manager Group can be determined by examining the full portfolio of funds advised by all of the RIAs in the Unique Manager Group and determining the fund type representing the greatest total PFRAUM.

The business rules that derive the Unique Manager Group artifacts can also examine certain artifacts of the RIAs of a given Unique Manager Group to derive an additional artifact value that characterizes the complexity for the given Unique Manager Group. Certain artifacts of the RIAs of a given Unique Manager Group can be processed to derive a Unique Manager Group artifact that characterizes the complexity and/or operating risk of the given Unique Manager Group. Specifically, a complexity score can be calculated as a function of a group of artifacts related to complexity and/or operating risk such as i) a count of RIAs of the Unique Manager Group, ii) the primary investment strategy of the Unique Manager Group, iii) a count of fund structures advised by the RIAs of the Unique Manager Group, iv) a count of fund types advised by the RIAs of the Unique Manager Group, iv) a count of private funds advised by the RIAs of the Unique Manager Group, v) a count of public funds advised by the RIAs of the Unique Manager Group, vi) a count of specific Service Providers of the RIAs of the Unique Manager Group, vii) a count of regulators of the RIAs of the Unique Manager Group, viii) a count of affiliates of the RIAs of the Unique Manager Group, ix) a count of limited partners of the RIAs of the Unique Manager Group (which can be involve counts of US and non-US limited partners), and x) a count of wrap fee programs of the RIAs of the Unique Manager Group. In all of these count values, the business rules can examine the count values to identify possible cases of redundancy in the count values and compensate for these cases.

The business rules that derive the Unique Manager Group artifacts can also examine certain artifacts of the RIAs of a given Unique Manager Group to derive an additional artifact value that characterizes the level of consistent and inconsistent expense practices of the given Unique Manager Group. Specifically, a matrix score of expense practices of the RIAs of the given Unique Manager Group can be derived in relation to the expense practices of a peer group related to the given Unique Manager Group. Note that within a peer group, an expense practice can be classified as being “common” if it is used by a majority (or other desired threshold percentage) of the members of the peer group. Otherwise, the expense practice can be classified as being “non-common.” It follows that a “common” expense practice employed by an RIA is viewed as being “consistent” within the peer group, while an “uncommon” expense practice employed by an RIA is viewed as being “inconsistent” within the peer group. These classifications of expenses practices can be arranged as a matrix of consistent/inconsistent expense practices of the RIAs of the given Unique Manager Group.

In phase 8, the data processing system 9 applies one or more predefined computer-implemented business rules to the artifacts stored in the primary database 11 for de-duplication purposes that removes duplicative information from the artifacts stored in the primary database 11.

In phase 9, the data processing system 9 performs roll-up calculations for the certain artifacts (referred to herein as “metrics” or “benchmark metrics” herein) stored in the primary database 11. The metric rollup calculations can be performed over Peer Groups of RIAs (or Managed Groups) with private funds and/or for groups of service providers for private funds to provide benchmark metrics for such groups. The resulting benchmark metrics can be associated with timestamps for the publication date of the underlying ADV form data and stored in the primary database 11. The benchmark metrics can be related to certain subject areas, such as expense practices, operational performance (productivity or work metrics), efficiency performance, complexity of business, consistency of form ADV filings, compliance of form ADV filings, and service provider market share (by strategy, by fund type, etc.). The benchmark metrics can be derived over time in conjunction with statistical analysis (average, min, max) of the benchmark metrics over time. Such benchmark metrics can be useful in evaluating the operational characteristics of a specific RIA (or specific Unique Manager Group) as compared to the others in the peer group and/or in searching for and identifying one or more RIAs or Unique Manager Groups that satisfy certain conditions or constraints with regards to the benchmark metrics.

Certain benchmark metrics (which can be based on personnel counts) can relate specifically to productivity (work) metrics. Other benchmark metrics (which can be based on the number of funds and number of clients (including limited partners) can relate specifically to efficiency performance. Other benchmark metrics (which can be based on the number of services providers and number of regulatory authorities) can relate specifically to the complexity of business. Other benchmark metrics can be based on other subjects, such as expense practices and PFRAUM, consistency of form ADV filings, compliance of form ADV filings, and service provider market share (by strategy, by fund type, etc.).

The workflow of phases of FIGS. 2A-2C that generates artifacts and additional artifacts and stores such artifacts in the primary database 11 can be carried out over periodic iterations (e.g., five days a week Tuesday through Friday and Sunday). As a result, the artifacts and additional artifacts stored in the primary database 11 can represent changes to the artifacts and additional artifacts over time, and the artifacts and additional artifacts stored in the primary database 11 can be processed to identify changes to the artifacts and additional artifacts over time for analysis. The relevant time period for such analysis can vary and be defined by user-input. Alternatively, the relevant time period for such analysis can be pre-defined as dictated by system design or other system parameters.

An example of the additional artifacts generated by the system for each RIA is depicted below in Table A. The first column of Table A lists the names (labels) of the additional artifacts and the second column of Table A gives the meaning of the additional artifacts.

TABLE A

| | |
|---|---|
| Strategy | Primary Investment Strategy, determined by the |
| | textual emphasis placed on asset classes used by the |
| | advisor to generate returns. Textual emphasis is |
| | based on a meta dictionary of key emphasis terms. |
| Advisor_Type | Dominant Fund Type, defined as the fund type with the largest |
| | percentage of a Private Fund Unique Gross Asset Value |
| Expense Type Disclosures | Expense Type(s) or Category(ies) disclosed by the RIA |
| NIP | Number of Non-Investment Professionals- defined |
| | the the difference between Full Time Equivalent and |
| | Investment Professional staff reported by the RIA |
| FTE_BN | Number of Employees per $Billion RAUM, defined |
| | as FTE/BN of RAUM for the RIA |
| IP_BN | Number of Investment Professionals per $Billion |
| | RAUM, defined as IP/BN of RAUM for the RIA |
| IP_FTE | Percentage of staff that is Investment Professionals, |
| | defined as IP/FTE for the RIA |
| NIP_BN | Number of Non-Investment Professionals per |
| | $Billion RAUM defined as NIP/BN of RAUM for the RIA |
| NIP_FTE | Percentage of staff that is Non-Investment |
| | Professionals, defined as NIP/FTE for the RIA |
| NIP_IP | Number of Non-Investment Professionals per |
| | Investment Professional, defined as NIP/IP for the RIA |
| PFRAUM | Total unique $ in Private Fund Regulatory Assets |
| | Under Management, defined as the aggregate |
| | amount of PFRAUM for the RIA |
| PICRAUM_Calc | Calculated percentage of RAUM that is PFRAUM, |
| | defined as PFRAUM/RAUM for the RIA |
| RAUM | Adjusted Total Reported Regulatory Amounts |
| | Under Management for the RIA |
| FundCount | sum of all private funds for the RIA |
| Sub_FundCount | total number of funds that the RIA sub-advises |
| WrapFee_Count | number of wrap-fee programs in which the RIA participates |
| MutualFund_Count | total number of funds that the RIA advises |
| AffiliateCount | total number of unique affiliates disclosed by the RIA |
| BeneficialOwnerCount | total number of limited partners disclosed by the RIA |
| NonUSBeneficialOwnerCount | total number of limited partners who are not United |
| | States citizens disclosed by the RIA |
| OfficeCount | total number of office locations disclosed by the RIA |
| RegulatoryRegimeCount | total number of regulators disclosed by the RIA |
| CCO | Chief Compliance Officer of the RIA |
| CEO | Chief Executive Officer of the RIA |
| CFO | Chief Finance Officer of the RIA |
| CLO | Chief Legal Officer of the RIA |
| COO | Chief Operating Officer of the RIA |
| CRO | Chief Risk Officer of the RIA |
| CTO | Chief Technology Officer of the RIA |
| HR | Head of Human Resources of the RIA |
| PrimaryAdministrator | the Primary Fund Administrators PFRAUM/PFRAUM for the RIA |
| Primary Auditor | Primary Fund Auditors PFRAUM/PFRAUM for the RIA |
| TotalBrokers | total number of Prime Brokers disclosed by the RIA |
| TotalCustodians | total number of Custodians disclosed by the RIA |
| UniqueAdministrators | total number of unique Administrators disclosed by the RIA |
| UniqueAuditors | total number of unique Auditors disclosed by the RIA |
| UniqueBrokers | total number of unique Prime Brokers disclosed by the RIA |
| UniqueCustodians | total number of unique Custodians disclosed by the RIA |
| ExternalMarketers | total number of unique 3rd-party Marketers disclosed by the RIA |
| Violations_Civil | total number of Civil Violations disclosed by the RIA |
| Violations_Criminal | total number of Criminal Violations disclosed by the RIA |
| Violations_Regulatory | total number of Regulatory Violations disclosed by the RIA |
| Affiliate_Violations_Civil | total number of Affiliate Civil Violations disclosed by the RIA |
| Affiliate_Violations_Criminal | total number of Affiliate Criminal Violations disclosed by the RIA |
| Affiliate_Violations_Regulatory | total number of Affiliate Regulatory Violations disclosed by the RIA |
| Amend_Violations_Civil | total number of Civil Violation Amendments disclosed by the RIA |
| Amend_Violations_Criminal | total number of Criminal Violation Amendments disclosed by the RIA |
| Amend_Violations_Regulatory | total number of Regulatory Violation Amendments disclosed by the RIA |
| Address | Primary Business Address of the RIA |
| City | Primary City of the RIA |
| CleanFax | Fax Number of the RIA |
| CleanPhone | Phone Number of the RIA |
| Clean URL | URL of the RIA |
| PrimaryCountry | Country of the RIA |

An example of the additional artifacts generated by the system for the complete universe of RIAs is depicted below in Table B. The first column of Table B lists the names (labels) of the additional artifacts and the second column of Table B gives the meaning of the additional artifacts.

TABLE B
additional artifacts for the complete universe of RIAs

| | |
|---|---|
| Csuite%Female | percentage of executive personnel of the complete |
| | universe of RIAs that is comprised of Female Employees |

An example of the additional artifacts generated by the system for the each peer group of RIAs is depicted below in Table C. The first column of Table C lists the names (labels) of the additional artifacts and the second column of Table C gives the meaning of the additional artifacts.

TABLE C
additional artifacts for peer group of RIAs

| | |
|---|---|
| CommonExpenseDisclosed | Common Expense Types or |
| | Categories disclosed by the peer |
| | group of RIAs |
| UnCommonExpenseDisclosed | Uncommon Expense Types or |
| | Categories disclosed by the peer |
| | group of RIAs |
| CommonExpenseNoDisclosed | Common Expense Types or |
| | Categories not disclosed by the peer |
| | group of RIAs |
| UnCommonExpenseNotDisclosed | Uncommon Expense Types or |
| | Categories not disclosed by the peer |
| | group of RIAs |

An example of the additional artifacts generated by the system for the each Unique Manage Group is depicted below in Table D. The first column of Table D lists the names (labels) of the additional artifacts and the second column of Table D gives the meaning of the additional artifacts.

TABLE D
additional artifacts for Unique Manager Group

| | |
|---|---|
| EffectiveDate | Date of inception according to the |
| | ADV filings of the oldest RIA in the |
| | Unique Manager Group |
| Strategy | Primary Investment Strategy of the |
| | Unique Manager Group |
| DiscRAUM | the amount of RAUM that the |
| | Unique Manager Group can invest |
| | without the permission of investors |
| FTE_BN | Ratio of total staff per billion of |
| | RAUM for the Unique Manager |
| | Group |
| IP_BN | Ratio of investment professionals per |
| | billion of RAUM for the Unique |
| | Manager Group |
| IP_FTE | Percentage of investment |
| | professionals to total staff for the |
| | Unique Manager Group |
| NIP_BN | Ratio of non-investment |
| | professionals per billion of RAUM |
| | for the Unique Manager Group |
| NIP_FTE | the percentage of non-investment |
| | professionals to total staff for the |
| | Unique Manager Group |
| NIP_IP | number of non-investment |
| | professionals supporting one |
| | investment professional for the |
| | Unique Manager Group |
| NonDiscRAUM | the amount of RAUM that the |
| | Unique Manager Group can invest |
| | with permission of the investors |
| PFRAUM | The Private Fund Regulatory Assets |
| | under Management for the Unique |
| | Manager Group |
| PICRAUM | Percentage of RAUM that is owned |
| | by Pooled Investment Companies |
| | that are not 40 Act or Business |
| | Development Companies for the |
| | Unique Manager Group |
| TotalRAUM | total amount of an Advisors |
| | Regulatory Assets under |
| | Management for the Unique Manager |
| | Group |
| AUMRankInBucket | numerical position within a size |
| | band for the Unique Manager Group |
| DiscAccts | total number of accounts where the |
| | Unique Manager Group does not |
| | have to seek an investor's permission |
| | to trade its assets |
| Exempt | defined as a Unique Manager Group |
| | with less than $115 mm of RAUM or |
| | a Unique Manager Group who |
| | advises only one Private Equity, Real |
| | Estate or Venture Capital fund |
| FTE | full time equivalents for the Unique |
| | Manager Group |
| Fund Types | the number of fund types advised by |
| | the Unique Manager Group advisor. |
| | A fund type is defined as a Hedge |
| | Fund, Private Equity Fund, Real |
| | Estate Fund, Venture Capital Fund, |
| | Securitized Asset Fund, Liquidity |
| | Fund or Other Fund |
| FundCount | total number of Private Funds |
| | advised by the Unique Manager |
| | Group |
| IP | the number of investment |
| | professionals for the Unique |
| | Manager Group |
| NIP | the number of non-investment |
| | professionals for the Unique |
| | Manager Group |
| NonDiscAccts | the number of accounts that the |
| | Unique Manager Group must seek |
| | permission from investors to trade |
| Primary Administrator | the Administrator who has the largest |
| | amount of PFRAUM as a percentage |
| | of all PFRAUM disclosed by the |
| | RIAs of the Unique Manager Group |
| Primary Auditor | the Auditor who has the largest |
| | amount of PFRAUM as a percentage |
| | of all PFRAUM disclosed by the |
| | RIAs of the Unique Manager Group |
| Primary Custodian | the Custodian who has the largest |
| | number of fund mentions as a |
| | percentage of all Custodian fund |
| | mentions disclosed by the RIAs of |
| | the Unique Manager Group |
| Primary Marketer | the Marketer who has the largest |
| | number of mentions as a percentage |
| | of all Marketer fund mentions |
| | disclosed by the RIAs of the Unique |
| | Manager Group |
| Primary Prime Broker | the Prime Broker who has the largest |
| | number of fund mentions as a |
| | percentage of all Prime Broker fund |
| | mentions disclosed by the RIAs of |
| | the Unique Manager Group |
| PrimaryAdministrator_PFRAUM | the total amount of Private Fund |
| | Regulatory Assets serviced by the |
| | Primary Administrator of the Unique |
| | Manager Group |
| PrimaryAdministrator_PFRAUM_PCT | the amount of PFRAUM serviced by |
| | the Primary Administrator of the |
| | Unique Manager Group divided by |
| | the total amount of the PFRAUM of |
| | the Unique Manager Group |
| PrimaryAuditor_PFRAUM | the total amount of Private Fund |
| | Regulatory Assets serviced by the |
| | Primary Auditory of the Unique |
| | Manager Group |
| PrimaryAuditor_PFRAUM_PCT | the amount of PFRAUM serviced by |
| | the Primary Auditor of the Unique |
| | Manager Group divided by the total |
| | amount of the PFRAUM of the |
| | Unique Manager Group |
| Sub_FundCount | the number of funds that the Unique |
| | Manager Group sub-advises |
| | (meaning they are not the lead |
| | advisor to the fund) |
| TotalAccounts | total number of discretionary and |
| | non-discretionary accounts advised |
| | by the Unique Manager Group |
| AUMBucket | particular size of Regulatory Assets |
| | under Management for the Unique |
| | Manager Group |
| CCO | Chief Compliance Officer of the |
| | Unique Manager Group |
| CEO | Chief Executive Officer of the |
| | Unique Manager Group |
| CFO | Chief Financial Officer of the Unique |
| | Manager Group |
| CLO | Chief Legal Officer of the Unique |
| | Manager Group |
| COO | Chief Operating Officer of the |
| | Unique Manager Group |
| CRO | Chief Risk Officer of the Unique |
| | Manager Group |
| CTO | Chief Technology Officer of the |
| | Unique Manager Group |
| HR | Head of Human Relations of the |
| | Unique Manager Group |
| Exempt_Status | Exempt Status of the Unique |
| | Manager Group |
| Fax | Fax Number of the Unique Manager |
| | Group |
| FilingDate | most recent ADV form filing date for |
| | the RIAs of the Unique Manager |
| | Group |
| Phone | Phone Number of the Unique |
| | Manager Group |
| Street | Street Address of Unique Manager |
| | Group |
| State | State of the Unique Manager Group |
| City | City of the Unique Manager Group |
| Zip | Zip Code of Unique Manager Group |
| Affiliate_Violations_Civil | total number of Civil Violations for |
| | affiliates of the RIAs of the Unique |
| | Manager Group |
| Affiliate_Violations_Criminal | total number of Criminal Violations |
| | for affiliates of the RIAs of the |
| | Unique Manager Group |
| Affiliate_Violations_Regulatory | total number of Regulatory |
| | Violations for affiliates of the RIAs |
| | of the Unique Manager Group |
| AffiliateCount | total number of affiliates disclosed by |
| | the RIAs of the Unique Manager |
| | Group |
| BeneficialOwnerCount | total number of beneficial owners |
| | disclosed by the RIAs of the Unique |
| | Manager Group |
| ExternalMarketers | total number of unique external |
| | marketers disclosed by the RIAs of |
| | the Unique Manager Group |
| MutualFundCount | total number of mutual funds advised |
| | by and disclosed by the RIAs of the |
| | Unique Manager Group |
| NonUSBeneficialOwnerCount | total number of non-US Beneficial |
| | Owners disclosed the RIAs of the |
| | Unique Manager Group |
| OfficeCount | total number of unique offices |
| | disclosed by the RIAs of the Unique |
| | Manager Group |
| RegulatoryRegimeCount | total number of unique offices |
| | disclosed by the RIAs of the Unique |
| | Manager Group |
| TotalBrokers | total number of Prime Brokers |
| | disclosed by the RIAs of the Unique |
| | Manager Group |
| TotalCustodians | total number of Custodians disclosed |
| | by the RIAs of the Unique Manager |
| | Group |
| UniqueAdministrators | total number of unique |
| | Administrators disclosed by the RIAs |
| | of the Unique Manager Group |
| UniqueAuditors | total number of unique Auditors |
| | disclosed by the RIAs of the Unique |
| | Manager Group |
| UniqueBrokers | total number of unique Prime |
| | Brokers disclosed by the RIAs of the |
| | Unique Manager Group |
| UniqueCustodians | total number of unique Custodians |
| | disclosed by the RIAs of the Unique |
| | Manager Group |
| Violations_Civil | total number of Civil Violations |
| | reported by RIAs of the Unique |
| | Manager Group |
| Violations_Criminal | total number of Criminal Violations |
| | reported by RIAs of the Unique |
| | Manager Group |
| Violations_Regulatory | total number of Regulatory |
| | Violations reported by RIAs of the |
| | Unique Manager Group |
| WrapFee_Count | total number of wrap fee programs |
| | reported by RIAs of the Unique |
| | Manager Group. |
| Comp1 | refers to compensation to the |
| | manager based on a percentage of |
| | assets under management |
| Comp2 | refers to compensation to the |
| | manager based on a per hour charge |
| Comp3 | refers to compensation to the |
| | manager based on a subscription fees |
| | for newsletters or periodicals |
| Comp4 | Refers compensation to the manager |
| | based fixed fees, other than |
| | subscription fees |
| Comp5 | refers to compensation to the |
| | manager based on commissions |
| Comp6 | refers to compensation to the |
| | manager based on a performance fees |
| Comp7 | refers to compensation to the |
| | manager based on other than Comp |
| | 1-6 |
| Continuous | refers to whether the RIAs of the |
| | Unique Manage Group provide |
| | continuous supervision over all |
| | private funds |
| Affiliates_DeltaAvg, Affiliates_DeltaMax, | mathematical difference between the |
| Affiliates_DeltaMin | Affilates artifact value for the Unique |
| | Manager Group and a peer group |
| | average, minimum and maximum |
| | values |
| BeneficialOwnerCount_DeltaAvg, | mathematical difference between the |
| BeneficialOwnerCount_DeltaMax, | BeneficialOwnersCount artifact |
| BeneficialOwnerCount_DeltaMin | value for the Unique Manager Group |
| | and a peer group average, minimum |
| | and maximum values |
| FTE_BN_DeltaAvg, FTE_BN_DeltaMin, | mathematical difference between the |
| FTE_BN_DeltaMax | FTE/BN artifact value for the Unique |
| | Manager Group and a peer group |
| | average, minimum and maximum |
| | values |
| FTE_DeltaAvg, FTE_DeltaMin, | mathematical difference between the |
| FTE_DeltaMax | FTE artifact value for the Unique |
| | Manager Group and a peer group |
| | average, minimum and maximum |
| | values |
| FTE_Fund_DeltaAvg, FTE_Fund_DeltaMin, | mathematical difference between the |
| FTE_Fund_DeltaMax | FTE/Fund artifact value for the |
| | Unique Manager Group and a peer |
| | group average, minimum and |
| | maximum values |
| FTE_LP_DeltaAvg, FTE_LP_DeltaMin, | mathematical difference between the |
| FTE_LP_DeltaMax | FTE/LP artifact value for the Unique |
| | Manager Group and a peer group |
| | average, minimum and maximum |
| | values |
| FTE_Offices_DeltaAvg, | mathematical difference between the |
| FTE_Offices_DeltaMin, | FTE/Offices artifact value for the |
| FTE_Offices_DeltaMax | Unique Manager Group and a peer |
| | group average, minimum and |
| | maximum values |
| Fund_Types_DeltaAvg, | mathematical difference between the |
| Fund_Types_DeltaMin, | Fund/Types artifact value for the |
| Fund_Types_DeltaMax | Unique Manager Group and a peer |
| | group average, minimum and |
| | maximum values |
| IP_BN_DeltaAvg, IP_BN_DeltaMin, | mathematical difference between the |
| IP_BN_DeltaMax | IP/BN artifact value for the Unique |
| | Manager Group and a peer group |
| | average, minimum and maximum |
| | values |
| IP_DeltaAvg, IP_DeltaMin, IP_DeltaMax | mathematical difference between the |
| | IP artifact value for the Unique |
| | Manager Group and a peer group |
| | average, minimum and maximum |
| | values |
| IP_Fund_DeltaAvg, IP_Fund_DeltaMin, | mathematical difference between the |
| IP_Fund_DeltaMax | IP/Fund artifact value for the Unique |
| | Manager Group and a peer group |
| | average, minimum and maximum |
| | values |
| IP_LP_DeltaAvg, IP_LP_DeltaMin, | mathematical difference between the |
| IP_LP_DeltaMax | IP/LP artifact value for the Unique |
| | Manager Group and a peer group |
| | average, minimum and maximum |
| | values |
| IP_Offices_DeltaAvg, IP_Offices_DeltaMin, | mathematical difference between the |
| IP_Offices_DeltaMax | IP/Offices artifact value for the |
| | Unique Manager Group and a peer |
| | group average, minimum and |
| | maximum values |
| NIP_BN_DeltaAvg, NIP_BN_DeltaMin, | mathematical difference between the |
| NIP_BN_DeltaMax | NIP/BN artifact value for the Unique |
| | Manager Group and a peer group |
| | average, minimum and maximum |
| | values |
| NIP_DeltaAvg, NIP_DeltaMin, | mathematical difference between the |
| NIP_DeltaMax | NIP artifact value for the Unique |
| | Manager Group and a peer group |
| | average, minimum and maximum |
| | values |
| NIP_FTE_DeltaAvg, NIP_FTE_DeltaMin, | mathematical difference between the |
| NIP_FTE_DeltaMax | NIP/FTE artifact value for the |
| | Unique Manager Group and a peer |
| | group average, minimum and |
| | maximum values |
| NIP_Fund_DeltaAvg, NIP_Fund_DeltaMin, | mathematical difference between the |
| NIP_Fund_DeltaMax | NIP/Fund artifact value for the |
| | Unique Manager Group and a peer |
| | group average, minimum and |
| | maximum values |
| NIP_IP_DeltaAvg, NIP_IP_DeltaMin, | mathematical difference between the |
| NIP_IP_DeltaMax | NIP/IP artifact value for the Unique |
| | Manager Group and a peer group |
| | average, minimum and maximum |
| | values |
| NIP_LP_DeltaAvg, NIP_LP_DeltaMin, | mathematical difference between the |
| NIP_LP_DeltaMax | NIP/LP artifact value for the Unique |
| | Manager Group and a peer group |
| | average, minimum and maximum |
| | values |
| NIP_Offices_DeltaAvg, | mathematical difference between the |
| NIP_Offices_DeltaMin, | NIP/Offices artifact value for the |
| NIP_Offices_DeltaMax | Unique Manager Group and a peer |
| | group average, minimum and |
| | maximum values |
| OfficeCount_DeltaAvg, | mathematical difference between the |
| OfficeCount_DeltaMin, | OfficeCount artifact value for the |
| OfficeCount_DeltaMax | Unique Manager Group and a peer |
| | group average, minimum and |
| | maximum values |
| PFRAUM_Fund_DeltaAvg, | mathematical difference between the |
| PFRAUM_Fund_DeltaMin, | PFRAUM/Fund artifact value for the |
| PFRAUM_Fund_DeltaMax | Unique Manager Group and a peer |
| | group average, minimum and |
| | maximum values |
| RegulatoryRegimeCount_DeltaAvg, | mathematical difference between the |
| RegulatoryRegimeCount_DeltaMin, | RegulatoryRegimeCount artifact |
| RegulatoryRegimeCount_DeltaMax | value for the Unique Manager Group |
| | and a peer group average, minimum |
| | and maximum values |
| UniqueAdministrators_DeltaAvg, | mathematical difference between the |
| UniqueAdministrators_DeltaMin, | UniqueAdministrators artifact value |
| UniqueAdministrators_DeltaMax | for the Unique Manager Group and a |
| | peer group average, minimum and |
| | maximum values |
| UniqueAuditors_DeltaAvg, | mathematical difference between the |
| UniqueAuditors_DeltaMin, | UniqueAuditors artifact value for the |
| UniqueAuditors_DeltaMax | Unique Manager Group and a peer |
| | group average, minimum and |
| | maximum values |
| UniqueBrokers_DeltaAvg, | mathematical difference between the |
| UniqueBrokers_DeltaMin, | UniqueBrokers artifact value for the |
| UniqueBrokers_DeltaMax | Unique Manager Group and a peer |
| | group average, minimum and |
| | maximum values |
| UniqueCustodians_DeltaAvg, | mathematical difference between the |
| UniqueCustodians_DeltaMin, | UniqueCustodians artifact value for |
| UniqueCustodians_DeltaMax | the Unique Manager Group and a |
| | peer group average, minimum and |
| | maximum values |
| UniqueMarketers_DeltaAvg, | mathematical difference between the |
| UniqueMarketers_DeltaMin, | UniqueMarketers artifact value for |
| UniqueMarketers_DeltaMax | the Unique Manager Group and a |
| | peer group average, minimum and |
| | maximum values |

An example of the additional artifacts generated by the system for the complete universe of Unique Manager Groups is depicted below in Table E. The first column of Table E lists the names (labels) of the additional artifacts and the second column of Table E gives the meaning of the additional artifacts.

TABLE E
additional artifacts for the complete universe of Unique Manager Groups

| | |
|---|---|
| FundCount for each Fund | total number of funds advised by the RIAs |
| Type - AUM Size Band | that are part Unique Manager Groups for the |
| | Fund Type - AUM Size Band |
| AdvisorCount for each | total number of RIAs of the Unique |
| Fund Type - AUM Size | Manager Groups for the Fund Type - AUM |
| Band | Size Band |
| ManagerCount for each | total number of Unique Manager Groups |
| Fund Type - AUM Size | that advise private fund assets for the Fund |
| Band | Type - AUM Size Band |
| PFRAUM for each Fund | total amount of Private Fund Regulatory |
| Type - AUM Size Band | Assets under Management advised by the |
| | RIAs of Unique Manager Groups for the |
| | Fund Type - AUM Size Band |
| FundCount for each | total number of funds advised by the RIAs |
| Strategy - AUM Size | that are part of Unique Manager Groups for |
| Band | the Strategy - AUM Size Band |
| AdvisorCount for each | total number of RIAs of Unique Manager |
| Strategy - AUM Size | Groups for the Strategy - AUM Size Band |
| Band | |
| ManagerCount for each | total number of Unique Manager Groups |
| Strategy - AUM Size | that advise private fund assets for each |
| Band | Strategy - AUM Size Band |
| PFRAUM | total amount of Private Fund Regulatory |
| | Assets under Management advised by the |
| | RIAs of all Unique Manager Groups |

An example of the additional artifacts generated by the system for each Service Provider (Administrators, Auditors, Prime Brokers, Custodians, and Third-party Marketers) is depicted below in Table F. The first column of Table F lists the names (labels) of the additional artifacts and the second column of Table F gives the meaning of the additional artifacts.

TABLE F

| | |
|---|---|
| FundCount | total number of funds serviced by the Service Provider |
| AdvisorCount | total number of RIAs serviced by the Service Provider |
| ManagerCount | total number of Unique Manager Groups serviced by |
| | the Service Provider |
| PFRAUM | total amount of Private Fund Regulatory Assets under |
| | Management serviced by the Service Provider |

An example of the additional artifacts generated by the system for the complete universe of Service Providers (or classes of Service Providers) is depicted below in Table G. The first column of Table G lists the names (labels) of the additional artifacts and the second column of Table G gives the meaning of the additional artifacts.

TABLE G
additional artifacts for the complete universe of Service Providers
(or classes of Service Providers)

| | |
|---|---|
| FundCount for each Fund | total number of funds serviced by Service |
| Type - AUM Size Band | Provider (or class of Service Providers) for |
| | the Fund Type - AUM Size Band |
| AdvisorCount for each | total number of RIAs serviced by Service |
| Fund Type - AUM Size | Provider (or class of Service Providers) for |
| Band | the Fund Type - AUM Size Band |
| ManagerCount for each | total number of Unique Manager Groups |
| Fund Type - AUM Size | serviced by Service Provider (or class of |
| Band | Service Providers) for the Fund Type - |
| | AUM Size Band |
| PFRAUM for each Fund | total amount of Private Fund Regulatory |
| Type - AUM Size Band | Assets under Management serviced by |
| | Service Provider (or class of Service |
| | Providers) for the Fund Type - AUM Size |
| | Band |
| FundCount for each | total number of funds serviced by Service |
| Strategy - AUM Size | Provider (or class of Service Providers) for |
| Band | the Strategy - AUM Size Band |
| AdvisorCount for each | total number of RIAs serviced by Service |
| Strategy - AUM Size | Provider (or class of Service Providers) for |
| Band | the Strategy - AUM Size Band |
| ManagerCount for each | total number of Unique Manager Groups |
| Strategy - AUM Size | serviced by Service Provider (or class of |
| Band | Service Providers) for the Strategy - AUM |
| | Size Band |
| PFRAUM | total amount of Private Fund Regulatory |
| | Assets under Management serviced by |
| | Service Provider (or class of Service |
| | Providers) for the Strategy - AUM Size |
| | Band |

An example of the additional artifacts generated by the system for each fund advised by an RIA is depicted below in Table H. The first column of Table H lists the names (labels) of the additional artifacts and the second column of Table H gives the meaning of the additional artifacts.

TABLE H
additional artifacts for each fund advised by an RIA

| # non-US | |
|---|---|
| Beneficial Owners | number of non-US limited partners of the fund |
| Fund Structure | refers to the legal form of a fund and can be a |
| | Master Fund, Feeder Fund, Mini-Master Fund, |
| | Single Fund or Fund of Funds |
| Fund Type | refers to a fund type, such as Hedge Fund, Private |
| | Equity Fund, Venture Capital Fund, Securitized |
| | Asset Fund, Liquidity Fund or Other Fund |
| Master-Feeder Fund | refers to Master-Feeder Fund Relationship |
| Relationship | |
| Fund Primary | refers to the Fund Primary Administrator, that |
| Administrator | Administrator who is named as the Fund |
| | Administrator and/or sends financial statements to |
| | limited partners for the funds |

An example of the additional artifacts generated by the system for executive level personnel of the RIAs is depicted below in Table I. The first column of Table I lists the names (labels) of the additional artifacts and the second column of Table I gives the meaning of the additional artifacts.

TABLE I
additional artifacts for executive level personnel of the RIAs

| | |
|---|---|
| NormalizedName | Name of the executive level person |
| Gender | Gender of the executive level person |
| skills | refers to accumulated skills and experience of |
| | the executive level person, which are based on |
| | various aspects of the advisors business model, |
| | including but limited to Fund Types, Fund |
| | Structures, Strategy, Regulatory Experience, |
| | Service Provider Experience and Company |
| | Size |

In phase 10, the information represented by the data stored in the primary database 11 is published to customers/users. Such publication can involve operations that process the data to identify daily changes of interest (such as new private funds, significant change in RAUM, new affiliations and service provider relationships, changes in executive level personnel, and/or new regulatory violations). The information can be packaged into a daily communication (in electronic-form) that highlights such information for electronic delivery and consumption to users/customers.

An example of such a daily communication is illustrated below, which includes fifteen (15) sections labeled as #1, #2, . . . #15 as follows:

The publication of phase 10 can also involve syndicating a limited part of the data stored in the primary database 11 to a third-party information distributors (for example Bloomberg, Reuters) for downstream delivery to users/customers.

The publication of phase 10 can also involve copying a limited part of the data stored in the primary database to a live portal database for user access. In this case, user permissions are used to control access and querying capability with respect to the live portal database. Users can access and query the live portal database in order to perform analysis (e.g., scenario-based analysis, time-series analysis, trend analysis and other modeling techniques) of the data stored in the live portal database. Such analysis can utilize the metrics and benchmark metrics stored in the live portal database. The analysis can also involve calculation of user-defined metrics and user-defined benchmark metrics on the data as well as the underling artifact data. The analysis can also involve monitoring of user-defined alert conditions with respect to the data stored in the live portal database as well as communication of related alert messages.

The query and analysis functionality of the live portal database can be useful in understanding the performance and other operational aspects of the Unique Manager Groups as represented by the data stored in the live portal database, which is particularly useful in performing “due diligence” analysis by institutional and retail limited partners who allocate capital to RIAs of alternative investments alternative investments. It also provides analysis that that can be used by other participants in the marketplace of alternative investments. Such participants can include and companies that offer services to alternative RIAs (including other asset managers, technology providers, compliance companies, law firms, accounting firms, fund administrators, custodians, investment banking firms, prime brokers, colleges and universities and anyone who might avail themselves of data on RIAs for competitive benchmarking purposes and relative self-assessment).

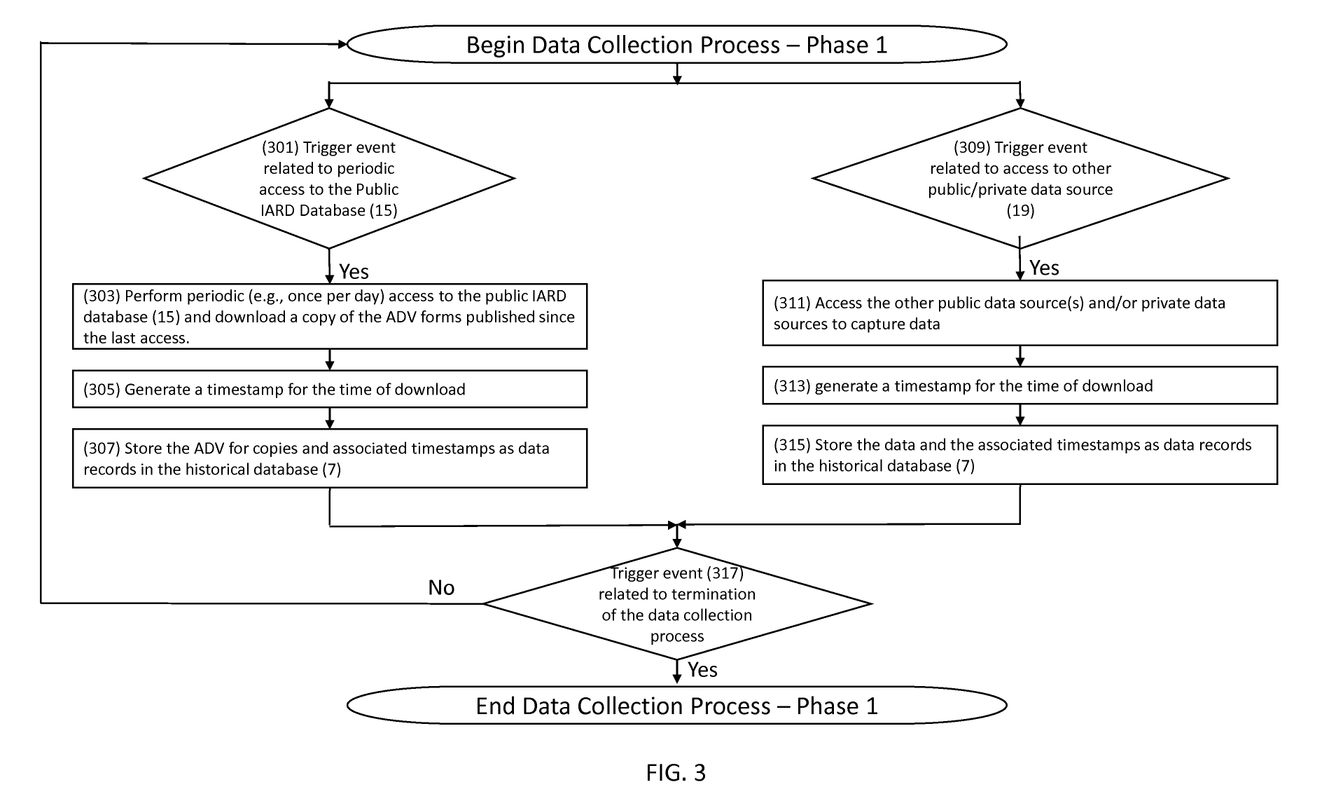

FIG. 3 is a flow chart illustrating exemplary operations carried out by the data collection server 5 in phase 1 of the workflow of FIGS. 2A-2B. In block 301, the data collection server 5 is configured to wait for the detection of a trigger event that is related to periodic access to the public IARD database 15. The trigger event can be generated periodically at specified times (e.g., Tuesday through Friday at 4 am Eastern Standard Time and Sunday at 3 pm Eastern Standard Time) and detected by an automated task scheduler as is well known in the computing arts. Upon detection of the trigger event, the operations continue to block 303 where the data collection server 5 performs the periodic access to the public IARD database 15 and downloads a copy of the ADV forms published since the last access. In block 305, the data collection server 5 generates a timestamp for the time of the download in block 303. In block 307, the data collection server 5 stores the ADV form data downloaded in block 303 and the timestamp generated in block 305 as data records (“unconditioned data”) in the historical database 7 and the operations continue to block 317 described below.

In block 309, the data collection server 5 is configured to wait for the detection of a trigger event that is related to access to other public and/or private data sources 17 and 19. The trigger event can be generated periodically at specified times (e.g., Tuesday through Friday at 5 am Eastern Standard Time and Sunday at 4 pm Eastern Standard Time) and detected by an automated task scheduler as is well known in the computing arts. Upon detection of the trigger event, the operations continue to block 311 where the data collection server 5 performs the access to other public and/or private data sources 17 and 19 to capture data from such sources. In block 313, the data collection server 5 generates a timestamp for the time of the access in block 311. In block 315, the data collection server 5 stores the data captured in block 311 and the timestamp generated in block 313 as data records (“unconditioned data”) in the historical database 7 and the operations continue to block 317 described below.

In block 317, the data collection server 5 determines whether a trigger event has been detected that is related to termination of the data collection process. If not, the operations continue to blocks 301 and 309 to wait for the next access. If so, the data collection process ends.

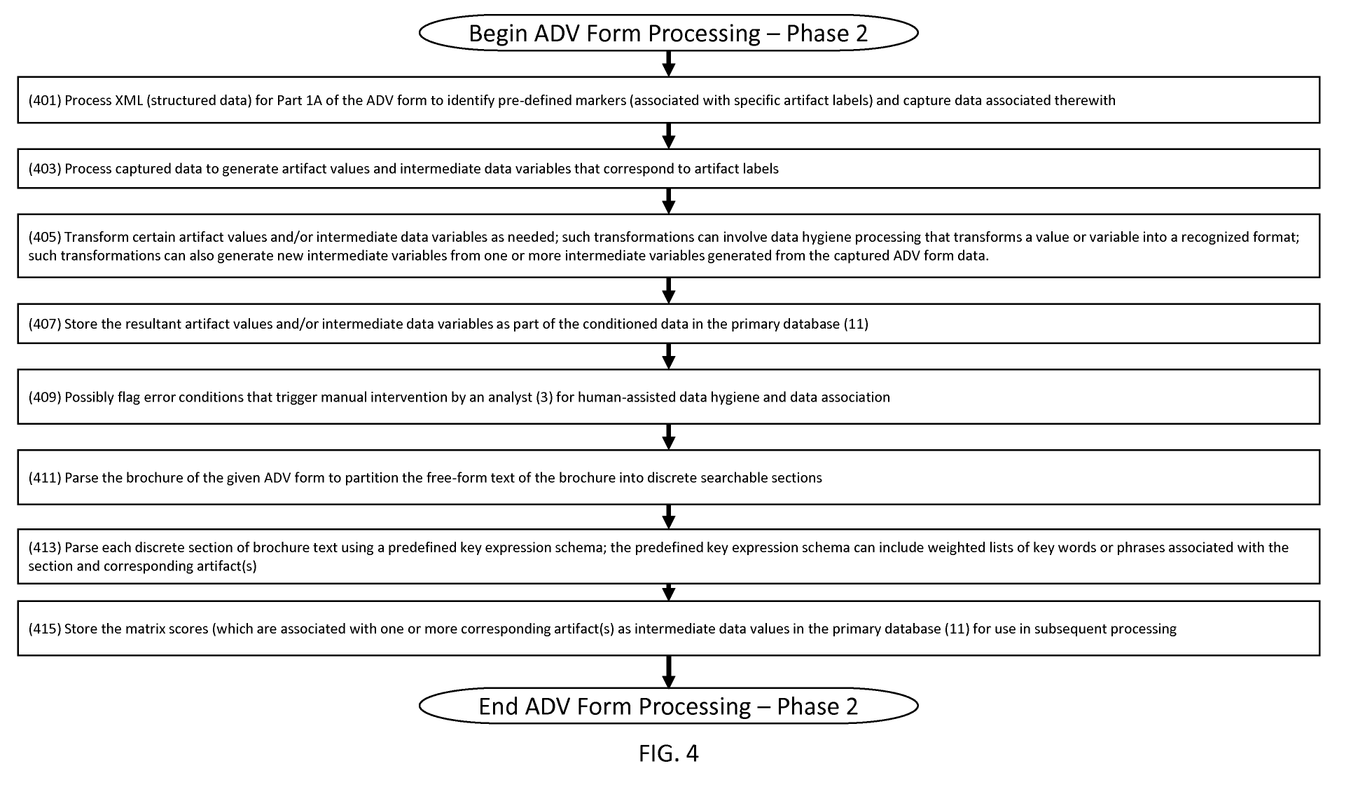

FIG. 4 is a flow chart illustrating exemplary operations carried out by the data processing system 9 in processing ADV form data for a given ADV form as part of phase 2 of the workflow of FIGS. 2A-2C.

The operations begin in block 401 where the XML (structured data) for part 1A of the ADV form data is processed to identify pre-defined markers (which are associated with specific artifact labels) and capture data associated therewith.

In block 403, the data captured in block 401 is processed to generate artifact values and intermediate data variables that correspond to specific artifact labels.

In block 405, certain artifact values and/or intermediate data variables can be transformed as needed. Such transformations can involve data hygiene processing that transforms a value or variable into a recognized format; such transformations can also generate new intermediate variables from one or more intermediate variables generated from the captured ADV form data.

In block 407, the artifact values and/or intermediate data variables that result from block 405 can be stored as part of the conditioned data in the primary database 11.

In block 409, error conditions can possibly be flagged that trigger manual intervention by an analyst for clean-up.

In block 411, the brochure of the given ADV form data is parsed to partition the free form text of the brochure into discrete searchable sections.

In block 413, each discrete section identified in block 411 is parsed using a predefined key expression schema associated with the section to create a matrix of scores for the section. The predefined key expression schema can include a weighted list of words or phrases associated with the section (and corresponding artifact(s)).

In block 415, the matrix scores (which are associated with one or more corresponding artifact(s)) can be stored as intermediate data values in the primary database 11 for use in subsequent processing.

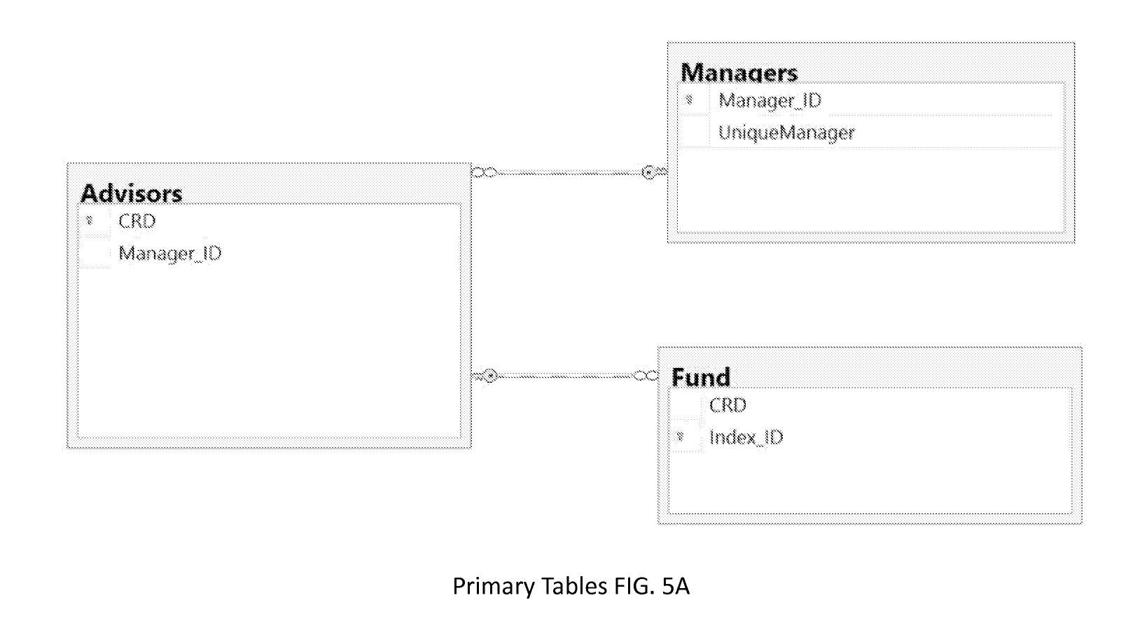

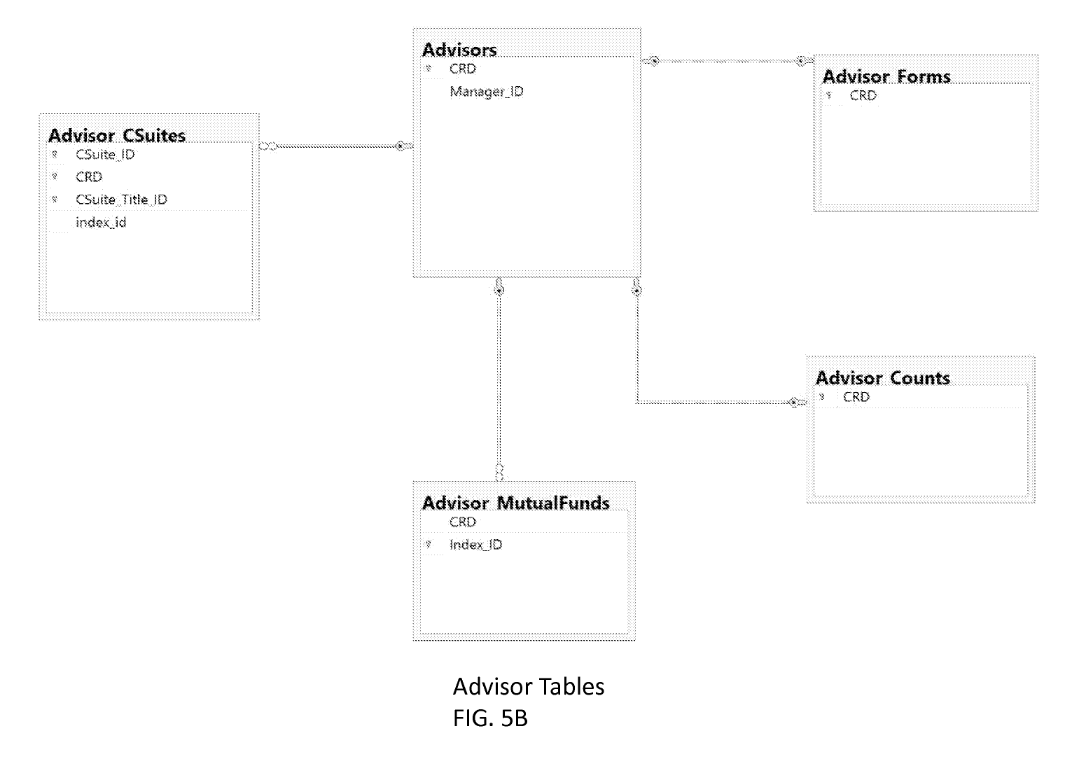

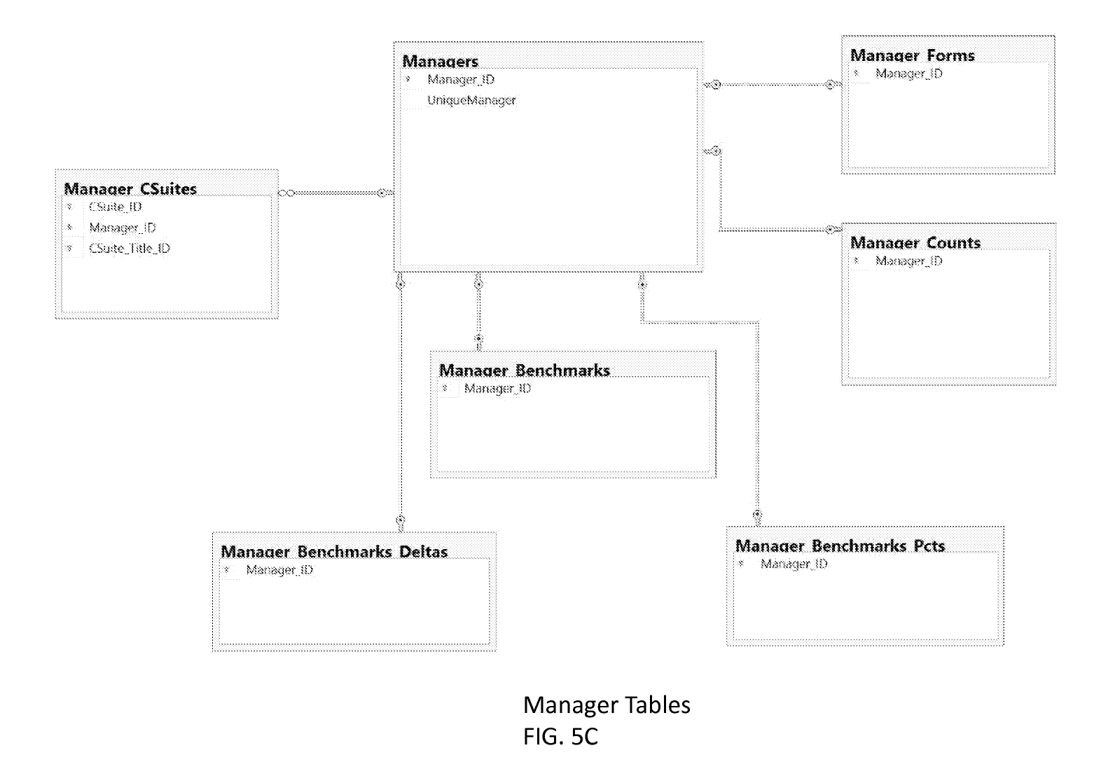

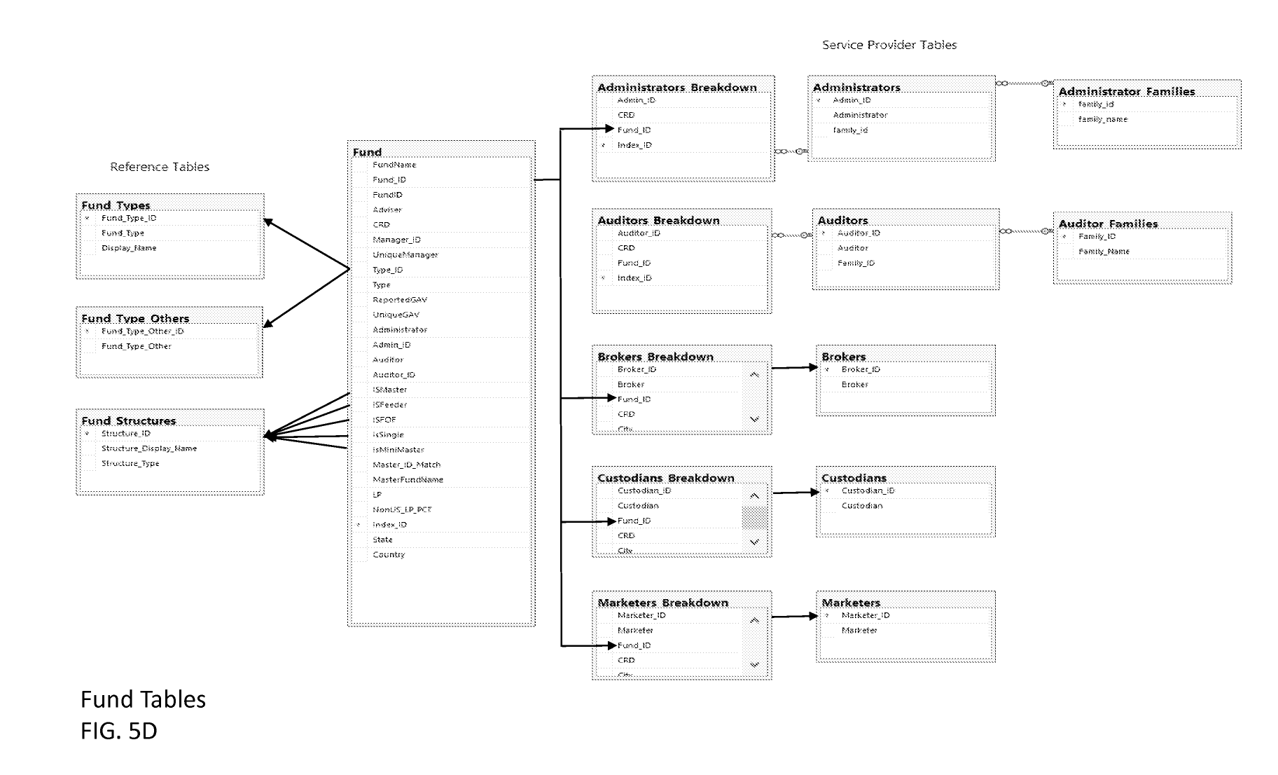

FIG. 5A is a schematic illustration of exemplary tables (labeled “Primary Tables”) that can be part of the primary database 11 to store the artifact data for RIAs (labeled “Advisors”), Unique Manager Groups (labeled “Managers”), and funds managed by RIAs (labeled “Funds”) with relations defined by keys as is well known in the computing arts.

FIG. 5B is a schematic illustration of exemplary tables (labeled “Advisor Tables”) that can be part of the primary database 11 to store the artifact data for RIAs (labeled “Advisors”), executive personnel of RIAs (labeled “Advisor C-Suites”), ADV form data for RIAs (labeled “Advisor Forms”), counts related to RIAs (labeled “Advisor Counts”) and funds advised by RIAs (labeled “Advisor Funds”) with relations defined by keys as is well known in the computing arts.

FIG. 5C is a schematic illustration of exemplary tables (labeled “Manager Tables”) that can be part of the primary database 11 to store the artifact data for Unique Manager Groups (labeled “Managers”), executive personnel or control person(s) of Unique Manager Groups (labeled “Manager C-Suites”), ADV form data for Unique Manager Groups (labeled “Manager Forms”), counts related to Unique Manager Groups (labeled “Manager Counts”), funds managed by Unique Manager Groups (labeled “Funds), and benchmarks and associated information for Unique Manager Groups (labeled “Manager Benchmarks,” “Manager Benchmark Deltas,” and “Manager Benchmark Pcts”) with relations defined by keys as is well known in the computing arts.

FIG. 5D is a schematic illustration of exemplary tables (labeled “Fund Tables”) that can be part of the primary database 11 to store the artifact data for funds advised by RIAs (labeled “Funds”), type of such funds (labeled “Fund Types” and “Fund Type Other”), and structures of such funds (labeled “Fund Structures”) as well as artifact data for service providers for such funds, including administrators (labeled “Administrators”), groups of related administrators (labeled “Administrator Families”), funds administrated by such administrators (labeled “Administrators Breakdown”), auditors (labeled “Auditors”), groups of related auditors (labeled “Auditor Families”), funds audited by such auditors (labeled “Auditors Breakdown”), brokers (labeled “Brokers”), funds brokered by such brokers (labeled “Brokers Breakdown”), custodians (labeled “Custodians”), funds held by such custodians (labeled “Custodians Breakdown”), marketers (labeled “Marketers”), and funds marketed by such marketers (labeled “Marketers Breakdown”) with relations defined by keys as is well known in the computing arts.

FIG. 6A is a view of an exemplary graphical user interface that is generated by the portal application server 13 and presented to a customer/user to allow the customer user to access the live portal database. The graphical user interface includes three columns of user-selectable buttons positioned above a window that presents a number of news stories to the customer/user.

The first column of user-selectable buttons includes a “Manager Selection Report” button, a “Manager View” button, a “CMDX Manager Profile” button, an “RIA Selection Report” button, and an “RIA View” button as shown.

Selection of the “Manager Selection Report” button presents an interface that allows the customer/user to filter, select or otherwise identify a particular Unique Manager Group and then view the profile of the particular Unique Manager Group.

Selection of the “Manager View” button presents an interface that allows the customer/user to select or otherwise identify a particular Unique Manager Group and then view the profile of the particular Unique Manager Group. The profile view of the particular Unique Manager Group can be similar for the operation of the “Manager Selection Report” interface and the “Manager View” interface.

Selection of the “CDMX Manager Profile” button presents an interface that allows the customer/user to view the profile of a particular Unique Manager Group. The profile of the Manager Group can include a primary address, primary phone number, primary investment strategy, CEO, CFO, CCO, count of full time employees, IP, NIP, number of office locations, primary investment strategy, RAUM, PFRAUM, private fund types and counts, count of affiliated RIAs and other affiliates, and list of peer group entities. An example of such a view is shown in FIG. 6B.

Selection of the “RIA Selection Report” button presents an interface that allows the customer/user to filter, select or otherwise identify a particular RIA and then view the profile of the particular RIA.

Selection of the “RIA View” button presents an interface that allows the customer/user to user to select or otherwise identify a particular RIA and then view the profile of the particular RIA. The profile of the RIA can be similar to that described above for a Unique Manager Group. The profile view of the particular RIA can be similar for the operation of the “RIA Selection Report” interface and the “RIA View” interface.

The second column of user-selectable buttons includes a “CMDX Manager Benchmarking” button, a “CMDX Client Benchmarking” button, and a “CMDX Market Share Analyzer” button as shown.

Selection of the “CMDX Manager Benchmarking” button presents an interface that allows the customer/user to perform analysis of Unique Manager Groups in conjunction with system-derived benchmarks for peers of Unique Manager Groups. A peer group of interest (a grouping of Unique Manager Groups) can be defined based on RAUM size, primary investment strategy or other artifacts of the Unique Manager Groups as dictated by user input or by the system. The customer/user can also identify one or more benchmark metrics of interest. The system can generate a report that is presented to the customer/user that ranks the Unique Manager Groups of the peer group for the one or more benchmarking metrics of interest.

Selection of the “CMDX Client Benchmarking” button presents an interface that allows the customer/user to perform analysis of Service Providers (such as Administrators or Auditors) in conjunction with system-derived benchmarks for Unique Manager Groups/RIAs that they service.

In one example, the customer/user can identify a strategy of interest, a RAUM size band, and a benchmark metric of interest. The system can generate a report that is presented to the customer/user that lists Service Provider(s), such as Auditors, that provide services to Unique Manager Groups/RIAs that match the strategy of interest and RAUM band of interest. The benchmark of interest can be used to filter or rank the matching Service Providers. An example of such an interface is shown in the window labeled “Auditor Client Prospecting” of FIG. 6C1.

In another example, the customer/user can identify a benchmark metric of interest. One or more groupings of Unique Manager Groups/RIAs can be defined based on RAUM size, dominant investment strategy, or other artifacts of the Unique Manager Groups as dictated by user input or by the system. An example of such an interface is labeled “Client Benchmarking Analysis Report” in FIG. 6C1.

The system can generate a report that ranks Service Providers (such as Administrators) according to the cumulative results of the benchmark metric of interest for those Unique Manager Groups/RIAs that match the defined grouping(s) of Unique Manager Group/RIAs. An example of such a report is shown in FIG. 6C2.

Selection of the “CMDX Market Share Analyzer Profile” button presents an interface that allows the customer/user to examine the market share of Service Providers (such as Administrators or Auditors). In one example, the customer/user can identify a strategy of interest and RAUM size of interest. The system can generate a report that is presented to the customer/user that lists Service Provider(s), such as Auditors, that provide services to Unique Manager Groups/RIAs that match the strategy of interest and RAUM size of interest. In another example, the user/customer can invoke the system to generate a composite report that details the market share of Service Providers by RAUM size or by investment strategy.

The third column of user-selectable buttons includes a “CMDX ADV Filing Changes” button, a “CMDX Fund Expense Practices Analysis” button, a “CMDX Times Series Analysis” button, a “CMDX Regulatory History Analysis” button, and a “CMDX Talent Identification Manager” button as shown.

Selection of the “CMDX ADV Filing Changes” button presents an interface that allows the customer/user to view all form ADV filings reported by the SEC involving changes to any artifact based on a system-generated comparison of the current artifacts to the prior ADV artifacts.

Selection of the “CMDX Fund Expense Practices Analysis” button presents an interface that shows the customer/user the expense practices categories reported by an RIA together with information regarding the RIA's use of consistent and inconsistent expense practice categories and terms relative to their peer group, defined by primary investment strategy. In FIG. 6D1, the customer/user selects a peer group, a primary strategy and an RIA within the peer group. The system generates a report that compares the expense practices of the selected RIA to those of the selected peer group, showing both consistent and inconsistent expense practices that are reported (disclosed) by the selected RIA as well as common and uncommon expense practices of the peer group that are not reported (not disclosed) by the selected RIA as shown in the 2 page report of FIGS. 6D2-1 to 6D2-2.

For example, in the example report shown in FIG. 6D2-2, the RIA “New Capital, LLC” reports (discloses) that it charges the following expenses practices categories that are consistent with its peers:
audit expenses;
consulting and professional fees (including, for example, fees for accounting services, fees for legal services, fees for political consultants, fees for renovation consultants, fees for actuaries, fees for forensic analysis, fees for expense consultants, fees for environmental studies, fees for engineering, fees for expert network consultants, and fees for economists);
custody fees;
general administration expenses (including, for example, fees for agents, fees for issuing checks/wire transfers/EFTs, general accounting expenses, external accounting expenses and property management);
investment related expenses (including, for example, expenses for subsidiary financing, sourcing expenses, rent expenses, staff expenses, expenses for acquisition and disposition of investments, hedging expenses, exchange fees, expenses for investment- related travel, accounting expenses, advice expenses, brokerage fees, due diligence expenses, legal expenses, trading costs, clearing and settlement expenses, broken deal expenses, sales costs, dealer costs, collections expenses, prime broker fees, transfer fees, transaction costs, subsidiary expenses, sales personnel expenses, commitment fees, paying agents fees, placement agent fees, restructuring expenses, structuring expenses, syndication fees, transfer fees, consent fees, divestment fees, IPO fees, investment banking fees);
legal expenses (including, for example, fees for judgements, fees for investigations, fees for settlements, fees for side letters, fees for most-favorable nations provisions, fees for class action lawsuits, fees for amending documents, fees for background checks, professional fees and legal registration fees);
management fees (including for example, asset-based administrative fees, sub-advisor management fees and advisory fees);
other fees and expenses (including for example, out-of-pocket expenses, other fees, other fund fees, and third-party expenses);
performance fees; and
tax fees (including, for example, fees for tax preparation, expense-entity taxes and personal property taxes).

The example report shown in FIGS. 6D2-2 also shows that the RIA “New Capital, LLC” does not report (does not disclose) that it charges the following expenses practices categories that are uncommon in its peers group:
advisor employee compensation (including, for example, advisor employee compensation expenses, internal accounting expenses, back office expenses, middle office expenses, internal operations expenses, secretarial expenses, salaries, personnel expenses, expenses for oversight of third party service providers, in-house administration expenses, employee insurance expenses, employee bonus expenses, compensation and benefits expenses, asset management personnel expenses, affiliates expenses, training expenses, trading operations expenses);
collateral management expenses;
communications expenses (including, for example, mailing expenses, telephone expenses, Internet expenses, FAX Costs, copying costs)
compliance expenses;
credit rating services expenses;
data and data management expenses (including, for example, Reuters expenses, Bloomberg expenses, Market Data expenses, database(s) expenses, data storage expenses, data services expenses, data processing expenses, data feed expenses)
family offices expenses;
fund accounting and administration expenses;
investment research expenses;
lobbying expenses (including, for example, fees to public and governmental relations firms);
sales commissions;
special purpose vehicle expenses;
subscription expenses;
technology expenses (including, for example, contact relationship management expenses, expenses for risk systems, expenses for valuation Systems, expenses for technology used by third-party consultants, expenses for disaster recovery, expenses for hosting, expenses for accounting software, expenses for investment software, expenses for research information systems. hardware expenses, software development expenses, general technology expenses, software expenses)
fees for trade errors;
fees for trademarks;
fees for treasury management;
advisor overhead expenses (including for example, utility expenses, stationary expenses, rent expenses, in-house expenses, furniture and fixture expenses, equipment expenses, facilities expenses)
wrap fees; and
licensing expenses.

The report can also show expense practice categories that are reported (disclosed) by the RIA “New Capital, LLC” that are uncommon/inconsistent in its peers group.

The report can also show expense practice that are not reported (not disclosed) by the RIA “New Capital, LLC” that are uncommon/inconsistent in its peers group.

For each given expense practice category or line item, the report can show the percent of RIAs of the peer group that report or disclose (or do not report or disclose) the use of the given expense practice category or line item as shown as shown in FIG. 6D2.

The report can also provide a table of counts in the consistent and inconsistent expense practice categories for the selected RIA and for percentage bands of the selected peer group as shown in FIG. 6D2-1. The report can also provide a bar graph of the density of expense practice categories reported (disclosed) for the selected RIA and for the selected peer group as shown in FIG. 6D2-1.

Selection of the “CMDX Times Series Analysis” button presents an interface that allows the customer/user to filter and then select the type and knowledge dates for any piece of information on an RIA that is in the operation database.

Selection of the “CMDX Regulatory History Analysis” button presents an interface that allows the customer/user to examine the regulatory history (including disciplinary violations) of specific RIAs or Unique Manager Groups.

Selection of the “CMDX Talent Identification Manager” button presents an interface that allows the customer/user to specify an executive level position title (such as CEO, CCO, CFO, CIO, CTO) and one or more additional constraints (such as staff size, geography, gender, time in position, number of violations, strategy type, fund type, fund structure, one or more administrators, etc.). The system then queries the data for the executive level personnel as stored in the live portal database to find one or more executive that holds or has held the specified executive level position title with personal data that matches the additional constraints. Information regarding the matching executive level personnel can be presented to the customer/user. An example of such an interface is shown in FIG. 6E.

The portal interface presented to the customer/user can also include a user-customized dashboard view as shown in FIG. 6F1. In this view, the customer/user selects from a list of RIAs in the live portal database to populate the left column of each row, and the customer/user selects from a list of available artifacts to create the rest of the columns of the table. An interface that provides for user selection of RIAs and artifacts is shown in FIG. 6F2. The customer/user also defines start date and end date of the dashboard view. The system displays material changes for the selected matrix over the time period defined by the start and end dates, with “material” defined based on change thresholds set by the user. Colored-in icons can be used to indicate change with direction of change. This allows for efficient inspection of change without moving away from the dashboard. The background color of an item in the matrix can indicate issue status. Rollover over an item in the matrix can expose detail of the item as shown in FIG. 6F3.

For each artifact, the customer/user may select a period-to-period delta threshold. This is the amount that an artifact needs to have changed during the selected period of time will determine whether it qualifies as a “material change” and gets displayed on the dashboard with a color indication thereof. The artifact delta threshold may be expressed as a percentage (e.g., +/−10%) or it may be defined as an absolute value change (e.g., number of affiliates changed by a count of 2 or more, or fund amount moves from below $1 Billion to above $1 Billion).

The portal interface presented to the customer/user can also include a tab view that shows only those parts of the dashboard view that have material changes. For example, the tab view can display only the rows of the dashboard view with artifacts that have exceeded the threshold of change within the time period defined by the start and end dates. An example of such a tab view (labeled “Exceptions”) is shown in FIG. 6F4.

The portal interface presented to the customer/user can also include a view that allows the customer/user to select an RIA and edit certain artifacts of the RIA (such as the Contact Name, Contact Phone and Contact Email) as shown in FIG. 6F5.

The information contained in the database 11 can be used for other analysis and related services. For example, the information contained in the database 11 can be analyzed for consistency of the information contained within the ADV form filings of a particular RIA and other publically available marketing materials of the RIA. In another example, the information contained in the database 11 can be analyzed to detect errors and inconsistencies with the ADV form filings of a particular RIA. This analysis can be performed over time to derive frequency of such errors and inconsistencies. The analysis can be linked to disclosed regulatory violations disclosed by the RIA or Unique Manager Group in order to identify possible operational and management issues.

There have been described and illustrated herein several embodiments of a data processing system and method for deriving and publishing knowledge of registered investment advisors and related entities. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

1. A system for deriving and managing RIA knowledge comprising:
a data collection server configured to automatically communicate with at least one data source to collect publically-available information pertaining to RIAs on a predefined periodic basis and stores such information in a first database; and
a data processing system configured to automatically process the publically-available information stored in the first database to derive artifacts representing the publically-available information as well as additional artifacts that represent useful information beyond the publically-available information, and stores the artifacts and additional artifacts in a second database for output and/or analysis by users.

2. A system according to claim 1, wherein:
the artifacts and additional artifacts include artifacts and additional artifacts that pertain to a particular RIA are derived from both structured and unstructured data reported by the particular RIA to a regulatory authority.

3. A system according to claim 2, wherein:
the data processing system is configured to automatically process the structured data reported by the particular RIA in order to generate at least one artifact for the particular RIA.

4. A system according to claim 3, wherein:
the at least one artifact for the particular RIA relates specifically to one of: the particular RIA, private funds advised by the particular RIA, asset levels, service providers of the particular RIA, disciplinary violations of the particular RIA, and an executive of the particular RIA.

5. A system according to claim 2, wherein:
the data processing system is configured to parse free form text reported by the particular RIA into discrete sections, parse at least one given section of the free form text using a predefined key expression schema to create a score matrix for the given section of free form text, and apply at least one predefined rule to the score matrix for the given section of free form text in order to generate at least one additional artifact for the particular RIA.

6. A system according to claim 5, wherein:
the at least one additional artifact generated by application of the at least one predefined rule to the score matrix for the given section of free form text represents one of: i) an investment strategy that is assigned from one a number predefined types of investment strategies and ii) an expense practice category that applies to funds advised by the RIA.

7. A system according to claim 2, wherein:
the at least one additional artifact for the particular RIA represents information selected from the group consisting of:
number of employees that do not perform investment advisory functions,
total value of private funds managed by the particular RIA,
count of total number of private funds managed by the particular RIA,
metrics that quantify operational characteristics of the particular RIA, and
counts related to disciplinary violations by the particular RIA.

8. A system according to claim 7, wherein:
the at least one additional artifact for the particular RIA represents information selected from the group consisting of:
i) primary investment strategy,
ii) dominant fund type,
iii) one or more expense type(s) or category(ies),
iv) number of non-investment professionals,
v) number of employees per $Billion RAUM,
vi) number of investment professionals per $Billion RAUM,
vii) percentage of staff that is investment professionals,
viii) number of non-investment professionals per $Billion RAUM,
ix) percentage of staff that is non-investment professionals;
x) number of non-investment professionals per investment professional
xi) total unique $ dollars in Private Fund Regulatory Assets Under Management,
xii) calculated percentage of RAUM that is PFRAUM,
xiii) adjusted total RAUM,
xiv) sum of all private funds,
xv) total number of funds that the RIA sub-advises,
xvi) number of wrap-fee programs in which the RIA participates,
xvii) total number of funds that the RIA advises,
xviii) total number of unique affiliates disclosed by the RIA,
xix) total number of limited partners disclosed by the RIA,
xx) total number of limited partners who are not United States citizens disclosed by the RIA,
xxi) total number of office locations disclosed by the RIA,
xxii) total number of regulators disclosed by the RIA,
xxiii) Chief Compliance Officer of the RIA,
xxiv) Chief Executive Officer of the RIA,
xxv) Chief Finance Officer of the RIA,
xxvi) Chief Legal Officer of the RIA,
xxvii) Chief Operating Officer of the RIA,
xxviii) Chief Risk Officer of the RIA,
xxix) Chief Technology Officer of the RIA,
xxx) Head of Human Resources of the RIA,
xxxi) Primary Fund Administrators PFRAUM/PFRAUM for the RIA,
xxxii) Primary Fund Auditors PFRAUM/PFRAUM for the RIA,
xxxiii) total number of Prime Brokers disclosed by the RIA,
xxxiv) total number of Custodians disclosed by the RIA,
xxxv) total number of unique Administrators disclosed by the RIA,
xxxvi) total number of unique Auditors disclosed by the RIA,
xxxvii) total number of unique Prime Brokers disclosed by the RIA,
xxxviii) total number of unique Custodians disclosed by the RIA,
xxxix) total number of unique 3rd-party Marketers disclosed by the RIA,
xl) total number of Civil Violations disclosed by the RIA,
xli) total number of Criminal Violations disclosed by the RIA,
xlii) total number of Regulatory Violations disclosed by the RIA,
xliii) total number of Affiliate Civil Violations disclosed by the RIA,
xliv) total number of Affiliate Criminal Violations disclosed by the RIA,
xlv) total number of Affiliate Regulatory Violations disclosed by the RIA,
xlvi) total number of Civil Violation Amendments disclosed by the RIA,
xlvii) total number of Criminal Violation Amendments disclosed by the RIA,
xlviii) total number of Regulatory Violation Amendments disclosed by the RIA,
xlix) Primary Business Address of the RIA,
l) Primary City of the RIA,
li) Fax Number of the RIA,
lii) Phone Number of the RIA,
liii) URL of the RIA, and
liv) Country of the RIA

9. A system according to claim 2, wherein:
at least one additional artifact for the particular RIA is derived by automatic processing of rules that involve one of conditional statements, weightings and rules for exceptional cases.

10. A system according to claim 1, wherein:
the data processing system is further configured to i) identify affiliations between RIAs to define groups of RIAs, and ii) derive additional artifacts that pertain to the groups of RIAs.

11. A system according to claim 10, wherein:
the data processing system derives additional artifacts for a given group of RIAs based upon artifacts for each one of the RIAs of the given group.

12. A system according to claim 11, wherein:
the data processing system derives additional artifacts for a given group of RIAs by automatic processing of rules that combine artifacts for each one of the RIAs of the given group.

13. A system according to claim 10, wherein:
the data processing system derives additional artifacts for a given group of RIAs based upon additional artifacts for each one of the RIAs of the given group.

14. A system according to claim 13, wherein:
the data processing system derives additional artifacts for a given group of RIAs by automatic processing of applying rules that combine additional artifacts for each one of the RIAs of the given group.

15. A system according to claim 10, wherein:
the additional artifacts include additional artifacts that pertain to a peer group of RIAs which are selected from the group including:
i) common expense types or categories disclosed by the peer group,
ii) uncommon expense types or categories disclosed by the peer group,
iii) common expense types or categories not disclosed by the peer group, and
iv) uncommon expense types or categories not disclosed by the peer group.

16. A system according to claim 10, wherein:
the groups of RIAs include one or more Unique Manager Groups of RIAs that have legal relationships with one another dictated by control with at least one RIA that advises on alternative investments having one or more private funds.

17. A system according to claim 16, wherein:
the additional artifacts include additional artifacts that pertain to a Unique Manager Group which are selected from the group including:
i) Date of inception according to the ADV filings of the oldest RIA in the Unique Manager Group,
ii) Primary Investment Strategy of the Unique Manager Group,
iii) the amount of RAUM that the Unique Manager Group can invest without the permission of investors;
iv) ratio of total staff per billion of RAUM for the Unique Manager Group,
v) ratio of investment professionals per billion of RAUM for the Unique Manager Group,
vi) percentage of investment professionals to total staff for the Unique Manager Group,
vii) ratio of non-investment professionals per billion of RAUM for the Unique Manager Group,
viii) the percentage of non-investment professionals to total staff for the Unique Manager Group,
ix) number of non-investment professionals supporting one investment professional for the Unique Manager Group,
x) the amount of RAUM that the Unique Manager Group can invest with permission of the investors,
xi) Private Fund Regulatory Assets under Management (PFRAUM) for the Unique Manager Group,
xii) Percentage of RAUM that is owned by Pooled Investment Companies that are not 40 Act or Business Development Companies for the Unique Manager Group,
xiii) total amount of an Advisors RAUM for the Unique Manager Group,
xiv) position within a size band for the Unique Manager Group,
xv) total number of accounts where the Unique Manager Group does not have to seek an investor's permission to trade its assets,
xvi) information representing a Unique Manager Group with less than $115 mm of RAUM or a Unique Manager Group who advises only one Private Equity, Real Estate or Venture Capital fund,
xvii) full time equivalents for the Unique Manager Group,
xviii) the number of fund types advised by the Unique Manager Group,
xix) total number of Private Funds advised by the Unique Manager Group,
xx) the number of investment professionals for the Unique Manager Group,
xxi) the number of non-investment professionals for the Unique Manager Group,
xxii) the number of accounts that the Unique Manager Group must seek permission from investors to trade,
xxiii) the Administrator who has the largest amount of PFRAUM as a percentage of all PFRAUM disclosed by the RIAs of the Unique Manager Group,
xxiv) the Auditor who has the largest amount of PFRAUM as a percentage of all PFRAUM disclosed by the RIAs of the Unique Manager Group,
xxv) the Custodian who has the largest number of fund mentions as a percentage of all Custodian fund mentions disclosed by the RIAs of the Unique Manager Group,
xxvi) the Marketer who has the largest number of mentions as a percentage of all Marketer fund mentions disclosed by the RIAs of the Unique Manager Group,
xxvii) the Prime Broker who has the largest number of fund mentions as a percentage of all Prime Broker fund mentions disclosed by the RIAs of the Unique Manager Group,
xxviii) the total amount of Private Fund Regulatory Assets serviced by the Primary Administrator of the Unique Manager Group,
xxix) the amount of PFRAUM serviced by the Primary Administrator of the Unique Manager Group divided by the total amount of the PFRAUM of the Unique Manager Group,
xxx) the total amount of Private Fund Regulatory Assets serviced by the Primary Auditory of the Unique Manager Group,
xxxi) the amount of PFRAUM serviced by the Primary Auditor of the Unique Manager Group divided by the total amount of the PFRAUM of the Unique Manager Group,
xxxii) the number of funds that the Unique Manager Group sub-advises,
xxxii) total number of discretionary and non-discretionary accounts advised by the Unique Manager Group,
xxxiii) particular size of RAUM for the Unique Manager Group,
xxxiv) Chief Compliance Officer of the Unique Manager Group,
xxxv) Chief Executive Officer of the Unique Manager Group,
xxxvi) Chief Financial Officer of the Unique Manager Group,
xxxvi) Chief Legal Officer of the Unique Manager Group,
xxxvii) Chief Operating Officer of the Unique Manager Group,
xxxviii) Chief Risk Officer of the Unique Manager Group,
xxxix) Chief Technology Officer of the Unique Manager Group,
xl) Head of Human Relations of the Unique Manager Group,
xli) Exempt Status of the Unique Manager Group,
xlii) Fax Number of the Unique Manager Group,
xliii) most recent ADV form filing date for the RIAs of the Unique Manager Group,
xliv) Phone Number of the Unique Manager Group,
xlv) Street Address of Unique Manager Group,
xlvi) State of the Unique Manager Group,
xlvii) City of the Unique Manager Group,
xlviii) Zip Code of Unique Manager Group
xlix) total number of Civil Violations for affiliates of the RIAs of the Unique Manager Group,
l) total number of Criminal Violations for affiliates of the RIAs of the Unique Manager Group,
li) total number of Regulatory Violations for affiliates of the RIAs of the Unique Manager Group,
lii) total number of affiliates disclosed by the RIAs of the Unique Manager Group,
liii) total number of beneficial owners disclosed by the RIAs of the Unique Manager Group,
liv) total number of unique external marketers disclosed by the RIAs of the Unique Manager Group,
lv) total number of mutual funds advised by and disclosed by the RIAs of the Unique Manager Group,
lvi) total number of non-US Beneficial Owners disclosed the RIAs of the Unique Manager Group,
lvii) total number of unique offices disclosed by the RIAs of the Unique Manager Group,
lviii) total number of unique offices disclosed by the RIAs of the Unique Manager Group,
lix) total number of Prime Brokers disclosed by the RIAs of the Unique Manager Group,
lx) total number of Custodians disclosed by the RIAs of the Unique Manager Group,
lxi) total number of unique Administrators disclosed by the RIAs of the Unique Manager Group,
lxii) total number of unique Auditors disclosed by the RIAs of the Unique Manager Group,
lxiii) total number of unique Prime Brokers disclosed by the RIAs of the Unique Manager Group,
lxiv) total number of unique Custodians disclosed by the RIAs of the Unique Manager Group,
lxv) total number of Civil Violations reported by RIAs of the Unique Manager Group,
lxvi) total number of Criminal Violations reported by RIAs of the Unique Manager Group,
lxvii) total number of Regulatory Violations reported by RIAs of the Unique Manager Group,
lxviii) total number of wrap fee programs reported by RIAs of the Unique Manager Group,
lxix) compensation to the manager based on a percentage of assets under management,
lxx) compensation to the manager based on a per hour charge,
lxxi) compensation to the manager based on a subscription fees for newsletters or periodicals,
lxxii) compensation to the manager based fixed fees, other than subscription fees,
lxxiii) compensation to the manager based on commissions,
lxxiv) compensation to the manager based on a performance fees,
lxxv) compensation to the manager based on other than compensation of lxix) to lxxiv),
lxxvi) whether the RIAs of the Unique Manage Group provide continuous supervision over all private funds,
lxxvii) mathematical difference between the Affilates artifact value for the Unique Manager Group and a peer group average, minimum and maximum values,
lxxviii) mathematical difference between the BeneficialOwnersCount artifact value for the Unique Manager Group and a peer group average, minimum and maximum values,
lxxix) mathematical difference between the FTE/BN artifact value for the Unique Manager Group and a peer group average, minimum and maximum values,
lxxx) mathematical difference between the FTE artifact value for the Unique Manager Group and a peer group average, minimum and maximum values,
lxxxi) mathematical difference between the FTE/Fund artifact value for the Unique Manager Group and a peer group average, minimum and maximum values,
lxxxii) mathematical difference between the FTE/LP artifact value for the Unique Manager Group and a peer group average, minimum and maximum values,
lxxxiii) mathematical difference between the FTE/Offices artifact value for the Unique Manager Group and a peer group average, minimum and maximum values,
lxxxiv) mathematical difference between the Fund/Types artifact value for the Unique Manager Group and a peer group average, minimum and maximum values,
lxxxv) mathematical difference between the IP/BN artifact value for the Unique Manager Group and a peer group average, minimum and maximum values,
lxxxvi) mathematical difference between the IP artifact value for the Unique Manager Group and a peer group average, minimum and maximum values,
lxxxvii) mathematical difference between the IP/Fund artifact value for the Unique Manager Group and a peer group average, minimum and maximum values,
lxxxviii) mathematical difference between the IP/LP artifact value for the Unique Manager Group and a peer group average, minimum and maximum values,
lxxxix) mathematical difference between the IP/Offices artifact value for the Unique Manager Group and a peer group average, minimum and maximum values,
xc) mathematical difference between the NIP/BN artifact value for the Unique Manager Group and a peer group average, minimum and maximum values,
xci) mathematical difference between the NIP artifact value for the Unique Manager Group and a peer group average, minimum and maximum values,
xcii) mathematical difference between the NIP/FTE artifact value for the Unique Manager Group and a peer group average, minimum and maximum values,
xcii) mathematical difference between the NIP/Fund artifact value for the Unique Manager Group and a peer group average, minimum and maximum values,
xciii) mathematical difference between the NIP/IP artifact value for the Unique Manager Group and a peer group average, minimum and maximum values
xciv) mathematical difference between the NIP/LP artifact value for the Unique Manager Group and a peer group average, minimum and maximum values,
xcv) mathematical difference between the NIP/Offices artifact value for the Unique Manager Group and a peer group average, minimum and maximum values,
xcvi) mathematical difference between the OfficeCount artifact value for the Unique Manager Group and a peer group average, minimum and maximum values,
xcvii) mathematical difference between the PFRAUM/Fund artifact value for the Unique Manager Group and a peer group average, minimum and maximum values,
xcviii) mathematical difference between the RegulatoryRegimeCount artifact value for the Unique Manager Group and a peer group average, minimum and maximum values,
xcix) mathematical difference between the UniqueAdministrators artifact value for the Unique Manager Group and a peer group average, minimum and maximum values,
c) mathematical difference between the UniqueAuditors artifact value for the Unique Manager Group and a peer group average, minimum and maximum values,
ci) mathematical difference between the UniqueBrokers artifact value for the Unique Manager Group and a peer group average, minimum and maximum values,
cii) mathematical difference between the UniqueCustodians artifact value for the Unique Manager Group and a peer group average, minimum and maximum values,
ciii) mathematical difference between the UniqueMarketers artifact value for the Unique Manager Group and a peer group average, minimum and maximum values,
civ) total number of funds advised by the RIAs that are part Unique Manager Groups for a Fund Type-AUM Size Band,
cv) total number of RIAs of the Unique Manager Groups for a Fund Type-AUM Size Band,
cvi) total number of Unique Manager Groups that advise private fund assets for a Fund Type-AUM Size Band,
cvii) total amount of Private Fund Regulatory Assets under Management advised by the RIAs of Unique Manager Groups for a Fund Type-AUM Size Band,
cviii) total number of funds advised by the RIAs that are part of Unique Manager Groups for a Strategy-AUM Size Band,
cix) total number of RIAs of Unique Manager Groups for a Strategy-AUM Size Band,
cx) total number of Unique Manager Groups that advise private fund assets for each Strategy-AUM Size Band, and
cxi) total amount of Private Fund Regulatory Assets under Management advised by the RIAs of all Unique Manager Groups.

18. A system according to claim 1, wherein:
the artifacts and additional artifacts include artifacts and additional artifacts that pertain to a service provider of one or more RIAs.

19. A system according to claim 18, wherein:
the additional artifacts that pertain to a service provider of one or more RIAs are selected from the group including:
i) total number of funds serviced by the service provider (or class of service provider) for a Fund Type-AUM Size Band,
ii) total number of RIAs serviced by the service provider (or class of service provider) for a Fund Type-AUM Size Band,
iii) total number of Unique Manager Groups serviced by the service provider (or class of service provider) for a Fund Type-AUM Size Band,
iv) total amount of Private Fund Regulatory Assets under Management serviced by the service provider (or class of service provider) for a Fund Type-AUM Size Band
v) total number of funds serviced by the service provider (or class of service provider) for a Strategy-AUM Size Band,
vi) total number of RIAs serviced by the service provider (or class of service provider) for a Strategy-AUM Size Band,
vii) total number of Unique Manager Groups serviced by the service provider (or class of service providers) for a Strategy-AUM Size Band, and
viii) total amount of Private Fund Regulatory Assets under Management serviced by the service provider (or class of service providers) for a Strategy-AUM Size Band.

20. A system according to claim 1, wherein:
the artifacts and additional artifacts include artifacts and additional artifacts that pertain to a fund advised by an RIA.

21. A system according to claim 20, wherein:
the artifacts and additional artifacts that pertain to a fund advised by an RIA are selected from the group including:
i) number of non-US limited partners of the fund,
ii) legal form of a fund (such as Master Fund, Feeder Fund, Mini-Master Fund, Single Fund and Fund of Funds),
iii) fund type (such as Hedge Fund, Private Equity Fund, Venture Capital Fund, Securitized Asset Fund, Liquidity Fund or Other Fund),
iv) information regarding Master-Feeder Fund Relationship, and
v) Fund Primary Administrator.

22. A system according to claim 1, wherein:
the artifacts and additional artifacts include artifacts and additional artifacts that pertain to executive level personnel of an RIA.

23. A system according to claim 22, wherein:
the artifacts and additional artifacts that pertain to executive level personnel of an RIA are selected from the group including:
i) name of an executive level person,
ii) gender of an executive level person, and
iii) information regarding accumulated skills and experience of an executive level person.

24. A system according to claim 1, wherein:
the data processing system is further configured to calculate metrics that pertain to operational characteristics of business entities over time, wherein the business entities are selected from the group including individual RIAs, groups of affiliated RIAs, peer groups of RIAs, and service providers.

25. A system according to claim 24, wherein:
the data processing system is further configured to perform roll-up calculations for the metrics that pertain to operational characteristics of business entities.

26. A system according to claim 25, wherein:
the rollup calculations of metrics is performed over peer groups of business entities to provide benchmark metrics for such peer groups, wherein the business entities are selected from the group including individual RIAs, groups of affiliated RIAs, and service providers.

27. A system according to claim 26, wherein:
said benchmark metrics are related to certain subject areas selected from the group including expense practices, operational performance (productivity or work metrics), efficiency performance, complexity of business, consistency of form ADV filings, compliance of form ADV filings, and service provider market share.

28. A system according to claim 1, wherein:
data stored in the second database represents changes to artifacts and additional artifacts generated by the system over time; and/or
data stored in the second database is published to a third database that is accessed by users for querying and/or analysis.

29. A system according to claim 28, wherein:
querying and analysis of the data stored in the third database provides for at least one of scenario-based analysis, time-series analysis, trend analysis and other modeling techniques for the data stored in the third database; and/or
analysis of data stored in the third database involve monitoring of user-defined alert conditions with respect to the data stored in the third database as well as communication of related alert messages.

30. A system according to claim 1, wherein:
data stored in the second database is processed to identify artifacts and additional artifacts of interest that are integrated into a periodic communication for communication to users.
